(19) United States
(12) Patent Application Publication
(10) Pub. No.: US 2026/0075518 A1
(43) Pub. Date: Mar. 12, 2026

(54) LINK TRANSMISSION METHOD AND APPARATUS, INFORMATION CONFIGURATION METHOD AND APPARATUS, AND COMMUNICATION DEVICE

(71) Applicant: VIVO MOBILE COMMUNICATION CO., LTD., Guangdong (CN)

(72) Inventors: Wei HUANG, Guangdong (CN); Dajie JIANG, Guangdong (CN)

(73) Assignee: VIVO MOBILE COMMUNICATION CO., LTD., Guangdong (CN)

(21) Appl. No.: 19/338,926

(22) Filed: Sep. 24, 2025

Related U.S. Application Data
(63) Continuation of application No. PCT/CN2024/084018, filed on Mar. 27, 2024.

(30) Foreign Application Priority Data
Mar. 31, 2023 (CN) 202310347726.1

(51) Int. Cl. H04W 52/02

(52) U.S. Cl. CPC H04W 52/0209

(57) ABSTRACT

This application discloses a link transmission method and apparatus, an information configuration method and apparatus, and a communication device. The link transmission method in embodiments of this application includes: A first device determines a transmission mode of a link between the first device and a second device, where the link between the first device and the second device includes at least one first link, and the first link is a low power communication link; and performs transmission on the link determined based on the transmission mode.

### CROSS-REFERENCE TO RELATED APPLICATIONS

This application is a Bypass continuation application of PCT International Application No. PCT/CN2024/084018 filed on Mar. 27, 2024, which claims priority to Chinese Patent Application No. 202310347726.1, filed in China on Mar. 31, 2023, which is incorporated herein by reference in its entirety.

### TECHNICAL FIELD

This application pertains to the field of communication technologies, and specifically, relates to a link transmission method and apparatus, an information configuration method and apparatus, and a communication device.

### BACKGROUND

In a related technology, to reduce power consumption of a device, a low power communication technology is introduced. Currently, a low power communication module may be added to a terminal device, to support multi-link data transmission of the terminal device, and implement bandwidth aggregation, load balancing, dynamic switching, or the like between a plurality of links. However, currently, how to implement link transmission of a related device is not determined in a case that the low power communication technology is introduced.

### SUMMARY

Embodiments of this application provide a link transmission method and apparatus, an information configuration method and apparatus, and a communication device.

According to a first aspect, a link transmission method is provided. The method is performed by a first device, and the method includes:

A first device determines a transmission mode of a link between the first device and a second device, where the link between the first device and the second device includes at least one first link, and the first link is a low power communication link; and
the first device performs transmission on the link determined based on the transmission mode.

According to a second aspect, an information configuration method is provided. The method is performed by a third device, and the method includes:

The third device sends first signaling to a first device and/or a second device, where
the first signaling is used to determine a transmission mode of a link between the first device and the second device, and perform transmission on the link determined based on the transmission mode; and the link between the first device and the second device includes at least one first link, and the first link is a low power communication link.

According to a third aspect, a link transmission apparatus is provided. The apparatus is used in a first device, and includes:
an execution module, configured to determine a transmission mode of a link between the first device and a second device, where the link between the first device and the second device includes at least one first link, and the first link is a low power communication link; and
a transmission module, configured to perform transmission on the link determined based on the transmission mode.

According to a fourth aspect, an information configuration apparatus is provided. The apparatus is used in a third device, and includes:
a sending module, configured to send first signaling to a first device and/or a second device, where
the first signaling is used to determine a transmission mode of a link between the first device and the second device, and perform transmission on the link determined based on the transmission mode; and the link between the first device and the second device includes at least one first link, and the first link is a low power communication link.

According to a fifth aspect, a communication device is provided. The communication device includes a processor and a memory, and the memory stores a program or an instruction that can be run on the processor; and when the program or the instruction is executed by the processor, the steps of the method according to the first aspect or the steps of the method according to the second aspect are implemented.

According to a sixth aspect, a communication device is provided. The communication device includes a processor and a communication interface. When the communication device is a first device, the processor is configured to determine a transmission mode of a link between the first device and a second device, where the link between the first device and the second device includes at least one first link, and the first link is a low power communication link; and the communication interface is configured to perform transmission on the link determined based on the transmission mode. When the communication device is a third device, the communication interface is configured to send first signaling to a first device and/or a second device, where the first signaling is used to determine a transmission mode of a link between the first device and the second device, and perform transmission on the link determined based on the transmission mode; and the link between the first device and the second device includes at least one first link, and the first link is a low power communication link.

According to a seventh aspect, a readable storage medium is provided. The readable storage medium stores a program or an instruction; and when the program or the instruction is executed by a processor, the steps of the method according to the first aspect are implemented, or the steps of the method the second aspect are implemented.

According to an eighth aspect, a wireless communication system is provided. The wireless communication system includes a first device and a second device, or includes a first device, a second device, and a third device. The first device may be configured to perform the steps of the method according to the first aspect, and the third device may be configured to perform the steps of the method according to the second aspect.

According to a ninth aspect, a chip is provided. The chip includes a processor and a communication interface, the communication interface is coupled to the processor, and the processor is configured to run a program or an instruction, to implement the steps of the method according to the first aspect, or implement the steps of the method according to the second aspect.

According to a tenth aspect, a computer program/program product is provided. The computer program/program product is stored in a storage medium, and the program/program product is executed by at least one processor, to implement the steps of the method according to the first aspect, or implement the steps of the method according to the second aspect.

### BRIEF DESCRIPTION OF DRAWINGS

FIG. 1 is a block diagram of a wireless communication system to which the embodiments of this application are applicable;

FIG. 2 is a flowchart of a link transmission method according to an embodiment of this application;

FIG. 3 is a schematic diagram of a link transmission process according to an embodiment of this application;

FIG. 4 is a schematic diagram of a wake-up manner based on low power communication according to an embodiment of this application;

FIG. 5 is a flowchart of an information configuration method according to an embodiment of this application;

FIG. 6 is a schematic diagram of a structure of a link transmission apparatus according to an embodiment of this application;

FIG. 7 is a schematic diagram of a structure of an information configuration apparatus according to an embodiment of this application; and

FIG. 8 is a schematic diagram of a structure of a communication device according to an embodiment of this application.

### DESCRIPTION OF EMBODIMENTS

The following clearly describes technical solutions in embodiments of this application with reference to the accompanying drawings in the embodiments of this application. Apparently, the described embodiments are some but not all of the embodiments of this application.

The terms “first”, “second”, or the like in this application are used to distinguish between similar objects, instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, “or” in this application represents at least one of connected objects. For example, “A or B” covers three solutions. To be specific, in a solution 1, A is included but B is not included; in a solution 2, B is included but A is not included; and in a solution 3, both A and B are included. The character “/” usually indicates an “or” relationship between associated objects.

The term “indication” in this application may be either a direct indication (or an explicit indication) or an indirect indication (or an implicit indication). The direct indication may be understood as that a sender explicitly notifies a receiver of content such as specific information, an operation that needs to be performed, or a request result in a sent indication. The indirect indication may be understood as that the receiver determines corresponding information based on an indication sent by the sender, or performs determining and determines an operation that needs to be performed, a request result, or the like based on a determining result.

It should be noted that the technologies described in the embodiments of this application are not limited to a long term evolution (LTE)/LTE-advanced (LTE-A) system, and may also be used in other wireless communication systems such as a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, or another system. The terms “system” and “network” in the embodiments of this application may be used interchangeably. The technologies described can be applied to both the systems and the radio technologies mentioned above as well as to other systems and radio technologies. A new radio (NR) system is described in the following descriptions for illustrative purposes, and the NR terminology is used in most of the following descriptions, although these technologies can also be applied to a system other than the NR system, for example, a 6th generation (6G) communication system.

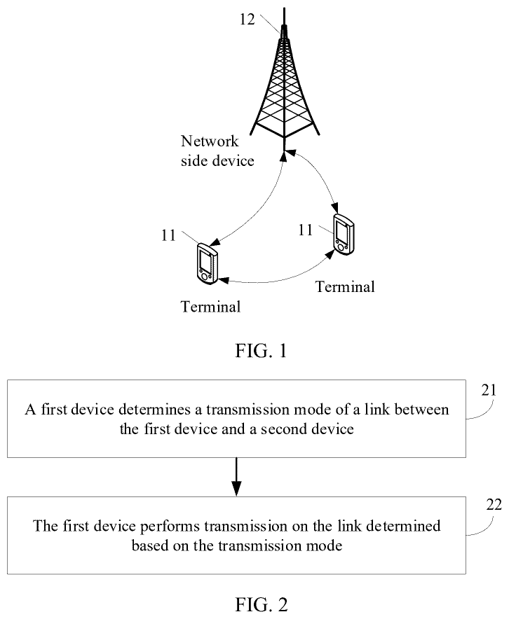

FIG. 1 is a block diagram of a wireless communication system to which the embodiments of this application are applicable. The wireless communication system includes a terminal 11 and a network side device 12. The terminal 11 may be a terminal side device, for example, a mobile phone, a tablet personal computer, a laptop computer, a notebook computer, a personal digital assistant (PDA), a palmtop computer, a netbook, an ultra-mobile personal computer (UMPC), a mobile internet device (MID), an augmented reality (AR) device, a virtual reality (VR) device, a robot, a wearable device, a flight vehicle, vehicle user equipment (VUE), maritime user equipment, pedestrian user equipment (PUE), a smart home (a home device having a wireless communication function, for example, a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart anklet chain, or the like), a smart wrist strap, smart clothes, or the like. A vehicle-mounted device may also be referred to as a vehicle-mounted terminal, a vehicle-mounted controller, a vehicle-mounted module, a vehicle-mounted component, a vehicle-mounted chip, or a vehicle-mounted unit. It should be noted that a specific type of the terminal 11 is not limited in the embodiments of this application. The network side device 12 may include an access network device or a core network device. The access network device may also be referred to as a radio access network (RAN) device, a radio access network function, or a radio access network unit. The access network device may include a base station, a wireless local area network (WLAN) access point (AS), a wireless fidelity (Wi-Fi) node, or the like. The base station may be referred to as a NodeB (NB), an evolved NodeB (eNB), a next generation NodeB (gNB), a new radio NodeB (NR NodeB), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another appropriate term in the field. Provided that same technical effect is achieved, the base station is not limited to a specified technical term.

To better understand the embodiments of this application, the following content is first described.

For a low power communication transmission technology, backscatter communication (BSC) is one of representative technologies for low power communication. Backscatter communication means that a backscatter communication device performs signal modulation by using a radio frequency signal in another device or an environment to communicate information of the backscatter communication device.

In addition to the low power sending technology represented by backscatter communication, how to implement low power receiving is also a key in the low power internet of things. Non-coherent detection receiving based on envelope detection is a key technology to implement low power receiving. This type of receiver mainly converts a signal to be low-frequency processed directly through envelope detection, and detects an amplitude of the received signal through envelope detection, which effectively reduces radio frequency complexity of the receiver, so that power consumption is reduced to 1/1000 to 1/100 of original power consumption, that is, reduced to a microwatt level. A low power non-coherent detection receiving technology may be used in a low power wake-up technology and a low power data receiving technology.

With development of communication technologies, more terminal devices (for example, smartphones or tablet computers) have a plurality of interfaces such as 4G, 5G, Wi-Fi, an IP network, or satellite communication. To make full use of a plurality of ports, a plurality of access manners, and redundant ISP resources of the terminal device, a multi-path transmission control protocol (MPTCP) is proposed. As an extension of a conventional transmission control protocol (TCP), the MPTCP is compatible with an existing network architecture and an existing protocol. It continues to provide a TCP socket for the application layer upwards, and uses a standard TCP protocol downwards to perform data transmission on a subflow, providing a transparent multi-path transmission capability for the user. In comparison with the TCP protocol that uses only a single path for data transmission, main advantages of using the MPTCP protocol for multi-path transmission are as follows: (1) A bandwidth of each interface is aggregated, improving a transmission bandwidth; (2) when applied to a wireless network, connections can be added or deleted when the user moves into or out of a coverage area without interrupting an end-to-end TCP connection; and (3) the terminal may select, based on a service requirement and a network condition, one or more appropriate network interfaces for data transmission, so that the terminal has a better adaptability to dynamically changing interface characteristics. Based on the foregoing advantages, the MPTCP plays an important role in multi-path transmission of the terminal device.

In principle, the MPTCP is an extended version of the TCP protocol, and can implement parallel data transmission through a plurality of paths at a transport layer. The MPTCP can use a plurality of TCPs as subflows for transmission at the same time, and uses two sequence numbers to ensure correct data transmission, where one sequence number is used at an MPTCP connection level, and the other sequence number is used in a TCP subflow. The sequence number in the TCP subflow is the same as that in a conventional TCP subflow, and is used for transmission control in a single subflow, to ensure correct transmission of data in the single subflow. An MPTCP connection-level sequence number ensures correct and sequential transmission of application-layer data. When a segment is lost, the MPTCP uses another subflow or performs segment retransmission in an original subflow as required, greatly improving a fast recovery capability.

The MPTCP can ensure multi-path transmission through effective measures such as connection management, path management, subflow selection, buffer management, data scheduling, or congestion control. Optimization objectives of the MPTCP include the following five points:
(1) throughput improvement, where a total throughput of an MPTCP connection needs to be not less than a total throughput of a single TCP connection on a best path of the MPTCP connection;
(2) fairness, where compared with using only one path, the MPTCP connection cannot occupy too many resources;
(3) balanced congestion, where if the foregoing two conditions are met, multi-path flows need to be transferred as many services as possible from a most congested path;
(4) security, where the MPTCP requires that security of the MPTCP be no worse than that of a single TCP connection; and
(5) resilience, where in a worst-case scenario, the MPTCP needs to be no less resilient than a conventional single-path TCP.

After the MPTCP enables a plurality of network interfaces for multi-path data transmission, end-to-end transmission performance is improved and the terminal device consumes more energy accordingly. How to balance a relationship between energy consumption and performance becomes a key problem in MPTCP energy management. According to different transmission efficiency and energy consumption models of different access networks, most existing energy consumption optimization solutions dynamically select an interface used by the MPTCP based on different characteristics of an upper-layer application. For example, in an energy consumption optimization solution based on an application layer, path selection, data scheduling, subflow selection, congestion control, or the like of the MPTCP are optimized based on a service type (for example, a file service, a video service, or a real-time streaming service), a file size, a quality of service (QoS) requirement, and an energy consumption requirement. However, this solution does not consider the physical layer link feature between a plurality of network interfaces. Therefore, the energy consumption optimization solution is not flexible and accurate. This is also the problem to be resolved in the solution in this application.

In some embodiments, the solution of this application mainly considers that a low power communication technology is applied to a terminal device of a non-internet of things device such as a mobile phone or a tablet, and is used for multi-link transmission of the terminal device, to implement balancing of multi-link transmission in terms of system performance and terminal power consumption.

In some embodiments, this embodiment of this application may be applied to an LTE system, a 5G NR system, and an NR evolved system, such as a 6G system or a 6G evolved system, and a plurality of systems that support multi-link transmission, such as an IEEE 802.11 system, a Bluetooth system, a LoRa system, a Zigbee system, a satellite communication system, a wireless optical communication system, or a backscatter communication system.

With reference to the accompanying drawings, the following describes in detail, by using some embodiments and application scenarios, a link transmission method and apparatus, an information configuration method and apparatus, and a communication device provided in the embodiments of this application.

FIG. 2 is a flowchart of a link transmission method according to an embodiment of this application. The method is performed by a first device, and the first device may optionally be a terminal, a network side device, or the like. As shown in FIG. 2, the method includes the following steps.

Step 21: The first device determines a transmission mode of a link between the first device and a second device.

Step 22: The first device performs transmission on the link determined based on the transmission mode.

Herein, the link between the first device and the second device includes at least one first link, and the first link is a low power communication link. The second device may optionally be a terminal, a network side device, or the like. For example, optional forms of the first device and the second device may include as follows: (1) Both the first device and the second device are terminals. (2) The first device is a terminal, and the second device is a network side device. (3) The first device is a network side device, and the second device is a terminal. (4) The first device is a BSC sending device, and the second device is a BSC receiving device.

In some embodiments, the first link may include at least one of the following:
(1) a backscatter communication link based on a third-party radio frequency carrier; or
(2) a low power communication link having an autonomous carrier generation capability.

In this way, in this embodiment, the transmission mode of the link between the first device and the second device is determined, the link between the first device and the second device includes at least one low power communication link, and transmission is performed on the link determined based on the transmission mode, so that multi-link transmission of a related device can be implemented in a case that a low power communication technology is introduced. In addition, the transmission mode is properly selected/determined, so that balance between system performance and power consumption of multi-link transmission can be implemented, and bandwidth aggregation, load balancing, dynamic switching, or the like between a plurality of links can be implemented on a premise that low power consumption of a system is ensured.

In some embodiments, the link between the first device and the second device may further include at least one second link, the second link is a communication link having a carrier generation capability, and average power consumption of the second link is higher than average power consumption of the first link, or peak power consumption of the second link is higher than peak power consumption of the first link.

For example, the link between the first device and the second device may have the following composition forms: (1) one first link and one second link; (2) one first link and a plurality of second links; (3) a plurality of first links and one second link; and (4) a plurality of first links and a plurality of second links.

In some embodiments, the second link is an active communication link having a carrier generation capability, and may include at least one of the following:
(1) a cellular link, where for example, the cellular link may be a cellular link in a communication system such as 4G, 5G, 6G, or B6G;
(2) a sidelink, where for example, the sidelink may be a sidelink in a communication system such as 4G, 5G, 6G, or B6G;
(3) a Wi-Fi link;
(4) a non-terrestrial network (NTN) link;
(5) an internet of things link, where for example, the internet of things link may be an internet of things link in a low power wide area network (LPWAN) such as NB-IoT; or
(6) a short-range communication link, where for example, the short-range communication link may be a short-range communication link such as Zigbee, Bluetooth, or LoRa.

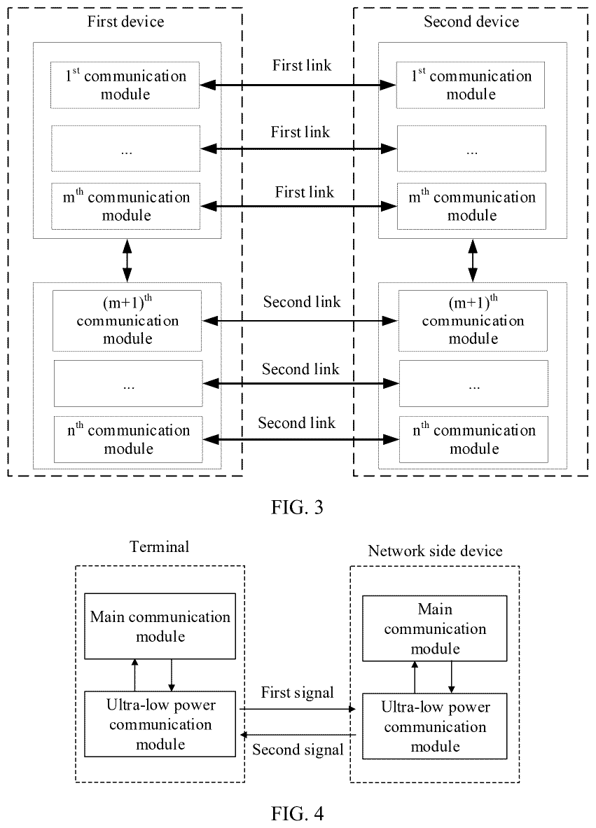

In some embodiments, an association relationship between the first device and the second device may be shown in FIG. 3. The first device includes a 1^{st} communication module, . . . , an m^{th} communication module, an (m+1)^{th} communication module, . . . , and an n^{th} communication module, and the 1^{st} communication module to the m^{th} communication module are low power communication modules, that is, the first device has m low power communication modules; and the second device includes a 1^{st} communication module, . . . , an m^{th} communication module, an (m+1)^{th} communication module, . . . , and an n^{th} communication module, and the 1^{st} communication module to the m^{th} communication module are low power communication modules, that is, the second device has m low power communication modules, where m and n are integers greater than or equal to 1, and n is greater than m. A first link is formed between the 1^{st} communication module of the first device and the 1^{st} communication module of the second device, . . . , and a first link is formed between the m^{th} communication module of the first device and the m^{th} communication module of the second device, that is, there are m low power communication links; and a second link is formed between the (m+1)^{th} communication module of the first device and the (m+1)^{th} communication module of the second device, . . . , and a second link is formed between the n^{th} communication module of the first device and the n^{th} communication module of the second device, that is, there are n-m low power communication links. The link between the first device and the second device includes m first links and n-m second links.

It may be understood that power consumption of a low power communication module is significantly lower than that of another communication module. For example, power consumption of the low power communication module is usually tens of microwatts to several milliwatts. However, because the another communication module is a communication module that has an autonomous carrier generation capability and has a common radio frequency component, power consumption of the another communication module is usually tens of milliwatts to thousands of milliwatts. In addition, costs of the low power communication module are significantly lower than those of the another communication module.

Communication modules in a same device may be communication modules of different physical entities, or may be communication modules of a same physical entity but different virtual logic. For example, in the first device, if a low power communication module and a second communication module (where the second communication module is used as an example) belong to a same network protocol stack, the low power communication module and the second communication module may belong to a same communication module in terms of a physical entity, but belong to different communication modules in terms of logic. Alternatively, although the low power communication module and the second communication module belong to a same network protocol stack, due to different hardware architectures, the low power communication module uses simplified hardware. Therefore, the low power communication module and the second communication module may also be communication modules of different physical entities. In addition, when the low power communication module and the second communication module do not belong to a same network protocol stack, the low power communication module and the second communication module may be communication modules of different physical entities, but may also use same physical hardware and belong to different communication modules in terms of logic.

In a same device, the low power communication module may communicate with another communication module through intra-core communication, or may communicate with another communication module through inter-core communication. If the low power communication module and the second communication module (where the second communication module is used as an example) belong to a same network protocol stack, for example, a 3GPP protocol stack, the low power communication module may communicate with the second communication module in the 3GPP protocol stack by using 3GPP signaling. However, if the low power communication module and the second communication module do not belong to a same network protocol stack, the low power communication module communicates with the second communication module through an inter-core or inter-stack interface, for example, an I2C interface.

In this embodiment of this application, the transmission mode of the link between the first device and the second device may be autonomously determined by the first device, or may be determined by a third-party device different from the first device and the second device and then sent to the first device, or may be determined by the second device and then sent to the first device. The determining a transmission mode of a link between the first device and a second device may include at least one of the following:

(a) The first device determines the transmission mode of the link between the first device and the second device based on a first parameter, where the first parameter is a transmission-related parameter between the first device and the second device.

Herein, the transmission mode of the link between the first device and the second device is autonomously determined by the first device, that is, the first device autonomously triggers entering or switching to a corresponding link transmission mode. The first parameter may optionally be a plurality of parameters across layers (for example, a physical layer, a link layer, a RAN higher layer, or an application layer), and may include at least one of the following:
a service type between the first device and the second device, where for example, the service type is a file service, a video service, a real-time streaming media service, or the like;
a size of a service packet between the first device and the second device;
a bandwidth requirement of a service between the first device and the second device;
a delay requirement of the service between the first device and the second device, where for example, the delay requirement may optionally be at least one of the following: a maximum delay, a minimum delay, or an average delay;
a delay jitter requirement between the first device and the second device, where for example, the delay jitter requirement may optionally be at least one of the following: a maximum delay jitter, a minimum delay jitter, or an average delay jitter;
a signal quality parameter of the link between the first device and the second device, where for example, the signal quality parameter of the link may optionally be at least one of the following: a reference signal received power (RSRP), a received signal strength indication (RSSI), a reference signal received quality (RSRQ), a signal to interference plus noise ratio (SINR), a signal to noise ratio (SNR), or the like;
a system parameter of the link between the first device and the second device, where for example, the system parameter may optionally be at least one of the following: a frame error rate, a channel bandwidth, or a round trip time (RTT); or
a power consumption parameter of the link between the first device and the second device, where for example, the power consumption parameter may optionally be at least one of the following: energy efficiency, average communication power consumption, peak communication power consumption, or the like.

In this way, a multi-link transmission mode may be selected/determined by combining a plurality of parameters across a physical layer, a link layer, a RAN higher layer, an application layer, or the like, to balance system performance and power consumption of multi-link transmission, and implement bandwidth aggregation, load balancing, dynamic switching, or the like between a plurality of links on a premise that low power consumption of a system is ensured.

In some embodiments, after determining the transmission mode of the link between the first device and the second device, the first device may indicate the determined transmission mode to the second device, so that the second device performs transmission on the link determined based on the transmission mode.

(b) The first device receives first signaling sent by a third device, and determines the transmission mode of the link between the first device and the second device based on the first signaling.

Herein, the transmission mode of the link between the first device and the second device is configured/indicated to the first device after being determined by the third device, that is, the third device schedules or configures the first/second device to enter or switch to a corresponding link transmission mode. The third device is a third-party device different from the first device and the second device, for example, a network side device.

In some embodiments, the first signaling may include at least one of the following:
an operating system instruction;
application layer signaling;
transport layer signaling;
network layer signaling; or
signaling in a protocol stack, where for example, the signaling in the protocol stack may be 3GPP signaling, Wi-Fi signaling, or the like; and the 3GPP signaling may optionally be at least one of the following: radio resource control (RRC) signaling, a medium access control control element (MAC CE), downlink control information (DCI), sidelink control information (SCI), physical layer signaling, or the like.

In some embodiments, the third device may determine the transmission mode of the link between the first device and the second device based on the first parameter. The first parameter may be described in (a) above, and details are not described herein again.

In some embodiments, after determining the transmission mode of the link between the first device and the second device based on the received first signaling, the first device may indicate the determined transmission mode to the second device, so that the second device performs transmission on the link determined based on the transmission mode.

(c) The first device receives first indication information sent by the second device, and determines the transmission mode of the link between the first device and the second device based on the first indication information.

Herein, the transmission mode of the link between the first device and the second device is indicated/sent to the first device after being determined by the second device, that is, the second device autonomously triggers entering or switching to a corresponding link transmission mode. The first indication information may be sent by using at least one of the following:
an operating system instruction;
application layer signaling;
transport layer signaling;
network layer signaling; or
signaling in a protocol stack, where for example, the signaling in the protocol stack may be 3GPP signaling, Wi-Fi signaling, or the like; and the 3GPP signaling may optionally be at least one of the following: RRC signaling, a MAC CE, DCI, SCI, physical layer signaling, or the like.

In some embodiments, the second device may determine the transmission mode of the link between the first device and the second device based on the first parameter. The first parameter may be described in (a) above, and details are not described herein again.

In some other embodiments, after determining the transmission mode of the link between the first device and the second device based on signaling of a third-party device different from the first device and the second device, the second device may indicate the determined transmission mode to the first device, so that the first device performs transmission on the link determined based on the transmission mode.

In this embodiment of this application, the transmission mode may include any one of the following:
a low power consumption mode, where in this mode, only one or more first links are enabled; or
a performance mode, where in this mode, at least one first link and at least one second link are enabled.

In some embodiments, the low power consumption mode may include at least one of the following:

### (a) First Aggregated Transmission Mode

Herein, the first aggregated transmission mode may also be referred to as a parallel transmission mode or an aggregated mode. The first aggregated transmission mode may meet at least one of the following:
(I) at least two first links are enabled, and the at least two first links communicate different data packets;
(II) a plurality of first links are enabled, and data on the plurality of first links is traffic-split at a protocol layer; and in some embodiments, the protocol layer may include at least one of the following: an application layer, a transport layer, a network layer, an access traffic steering, switching, and splitting-lower layer ATSSS-LL layer, a non-access stratum (NAS), a radio resource control (RRC) layer, a service data adaptation protocol (SDAP) layer, a packet data convergence protocol (PDCP) layer, a radio link control (RLC) layer, a media access control MAC layer, or the like;
(III) a plurality of first links are enabled, and data packets sent by subflows corresponding to the plurality of first links each have at least one sequence number, used for data reassembly and/or sorting; or
(IV) a plurality of first links are enabled, and the plurality of first links are communicated in parallel.

### (b) First Redundant Transmission Mode

Herein, the first redundant transmission mode may also be referred to as a backup mode. The first redundant transmission mode may meet at least one of the following:
(I) at least two first links are enabled, and the at least two first links communicate a same data packet;
(II) a plurality of first links are enabled, and data on the plurality of first links is traffic-split at a protocol layer; and in some embodiments, the protocol layer may include at least one of the following: an application layer, a transport layer, a network layer, an ATSSS-LL layer, a non-access stratum NAS, an RRC layer, an SDAP layer, a PDCP layer, an RLC layer, a MAC layer, or the like;
(III) a plurality of first links are enabled, and data packets sent by subflows corresponding to the plurality of first links each have at least one sequence number, used for data reassembly and/or sorting; or
(IV) a plurality of first links are enabled, and the plurality of first links are communicated in parallel.

### (c) First Optimal Link Transmission Mode

Herein, the first optimal link transmission mode may also be referred to as a single-link transmission mode, that is, transmission is performed through only one sublink. The first optimal link transmission mode meets the following: only one first link is enabled at the same time.

In some embodiments, the first link enabled in the first optimal link transmission mode meets at least one of the following:
a round trip time RTT of the first link is minimum;
an available bandwidth of the first link is maximum;
link quality of the first link is best;
power consumption of the first link is lowest; or
a packet loss rate of the first link is lowest.

In some embodiments, the performance mode may include at least one of the following:

### (a) Second Aggregated Transmission Mode

Herein, the second aggregated transmission mode may also be referred to as a parallel transmission mode or an aggregated mode. The second aggregated transmission mode meets at least one of the following:
(I) the first link and the second link communicate different data packets, for example, at least one first link (that is, one or more first links) and at least one second link (that is, one or more second links) may communicate different data packets;
(II) data on the first link and data on the second link are traffic-split at a protocol layer, for example, data on at least one first link (that is, one or more first links) and data on at least one second link (that is, one or more second links) may be traffic-split at the protocol layer; and the protocol layer may include at least one of the following: an application layer, a transport layer, a network layer, an ATSSS-LL layer, a non-access stratum NAS, an RRC layer, an SDAP layer, a PDCP layer, an RLC layer, a MAC layer, or the like;
(III) data packets sent by subflows corresponding to the first link and the second link each have at least one sequence number, used for data reassembly and/or sorting, for example, data packets sent by subflows corresponding to at least one first link (that is, one or more first links) and at least one second link (that is, one or more second links) each may have at least one sequence number; or
(IV) the first link and the second link are communicated in parallel, for example, at least one first link (that is, one or more first links) and at least one second link (that is, one or more second links) may be communicated in parallel.

### (b) Second Redundant Transmission Mode

Herein, the second redundant transmission mode may also be referred to as a backup mode. The second redundant transmission mode may meet at least one of the following:
(I) the first link and the second link communicate a same data packet, for example, at least one first link (that is, one or more first links) and at least one second link (that is, one or more second links) may communicate a same data packet;
(II) data on the first link and data on the second link are traffic-split at a protocol layer, for example, data on at least one first link (that is, one or more first links) and data on at least one second link (that is, one or more second links) may be traffic-split at the protocol layer; and the protocol layer may include at least one of the following: an application layer, a transport layer, a network layer, an ATSSS-LL layer, a non-access stratum NAS, an RRC layer, an SDAP layer, a PDCP layer, an RLC layer, a MAC layer, or the like;
(III) data packets sent by subflows corresponding to the first link and the second link each have at least one sequence number, used for data reassembly and/or sorting, for example, data packets sent by subflows corresponding to at least one first link (that is, one or more first links) and at least one second link (that is, one or more second links) each may have at least one sequence number; or
(IV) the first link and the second link are communicated in parallel, for example, at least one first link (that is, one or more first links) and at least one second link (that is, one or more second links) may be communicated in parallel.

### (c) Second Optimal Link Transmission Mode

Herein, the second optimal link transmission mode may meet at least one of the following:
(I) at least one first link and one second link are enabled at the same time, that is, there is one and only one second link enabled;
(II) data on the first link and data on the second link are traffic-split at a protocol layer; and in some embodiments, the protocol layer may include at least one of the following: an application layer, a transport layer, a network layer, an ATSSS-LL layer, a non-access stratum NAS, an RRC layer, an SDAP layer, a PDCP layer, an RLC layer, a MAC layer, or the like;
(III) data packets sent by subflows corresponding to the first link and the second link each have at least one sequence number, used for at least one of the following: data reassembly, data sorting, or data combination, for example, data packets sent by subflows corresponding to at least one first link (that is, one or more first links) and one second link each may have at least one sequence number; or
(IV) the first link and the second link are communicated in parallel, for example, at least one first link (that is, one or more first links) and one second link may be communicated in parallel.

In some embodiments, the second link enabled in the second optimal link transmission mode meets at least one of the following:
a round trip time RTT of the second link is minimum;
a bandwidth of the second link is maximum;
link quality of the second link is best;
power consumption of the second link is lowest; or
a packet loss rate of the second link is lowest.

### (d) Serial Transmission Mode

Herein, the serial transmission mode meets at least one of the following: the first link and the second link are communicated in series. For example, at least one first link (that is, one or more first links) and at least one second link (that is, one or more second links) may be communicated in series.

In some embodiments, in the serial transmission mode, the first link is used to wake up or enable one or more second links; and/or the first link is used to communicate signaling or data, and the second link is used to communicate data.

A serial transmission mode in a feasible performance mode is based on a wake-up function of the low power communication module. For example, as shown in FIG. 4, when there is no service or a communication rate required by the service is low, a terminal performs communication and measurement through a low power communication module of the terminal and a low power communication module of a network side device (for example, a base station) by using a first signal and a second signal. This helps the terminal and the base station save energy. When a service (for example, a service of a high communication rate requirement) arrives, the terminal indicates, through the low power communication module, the network side device to enable a main communication module, and the terminal also communicates with the main communication module of the network side device through the main communication module, to meet a service requirement of a high communication rate requirement.

In some embodiments, another application scenario of the serial transmission mode in the performance mode is as follows: Signaling, a synchronization signal, a paging signal, or the like are carried based on the low power communication module and the corresponding first link; and once there is data to be scheduled, another communication module or the second link is enabled to carry corresponding signaling and a corresponding data flow, to implement traffic splitting of control signaling and data on a physical link. In this way, in a non-data transmission phase, the low power communication module can be fully utilized to reduce system power consumption, and at the same time, a normal connection to a network is maintained, thereby reducing a network access delay.

In this embodiment of this application, because the first link and one or more second links may belong to a same protocol stack, or may belong to different protocol stacks, a manner of traffic-splitting data on the first link/second link at the protocol layer may vary based on whether the links are of a same protocol stack. If the first link and the second link belong to different protocol stacks, a policy similar to an MPTCP/MPUDP may be used to perform traffic splitting at a TCP/UDP layer, and two sequence numbers are used to ensure correct data transmission, where one sequence number is used at an MPTCP/MPUDP connection layer, and the other sequence number is used in a TCP subflow. The MPTCP designs a sub-sequence number mapping mechanism, and a data packet sent on each subflow corresponds to a connection-level sequence number, to ensure that a receiving end can correctly reassemble data packets received on different subflows. Similarly, a manner same as access traffic steering, switching, and splitting (ATSSS) in 3GPP may be used to support traffic splitting of a 3GPP link and a non-3GPP link. According to an ATSSS rule provided by the network, a device having an ATSSS capability can traffic-split, migrate, and separate MA PDU session traffic between the 3GPP link and the non-3GPP link. This is referred to as a “traffic splitting function”. In addition, the device having the ATSSS capability may support one or more types of traffic splitting functions:
(1) an upper-layer traffic splitting function above an IP layer may use an MPTCP protocol for splitting; and
(2) for a traffic splitting function running below the IP layer may traffic-split, migrate, and separate all types of traffic, including TCP traffic, UDP traffic, ethernet traffic, or the like, by defining an underlying traffic splitting function such as an ATSSS-LL function.

In some embodiments, if the first link and the second link belong to a same protocol stack, traffic splitting policies corresponding to the first link and the second link may be different. For example, both the first link and the second link belong to a cellular network and both support 3GPP. 3GPP supports carrier aggregation (CA) and dual-connectivity (DC). Both CA and DC support the terminal to be connected to a plurality of carriers to improve a system throughput. However, in carrier aggregation CA, data is traffic-split at a PDCP layer; and in CA, data is traffic-split at a MAC layer. Similarly, another network protocol (for example, a Wi-Fi protocol) also has a corresponding traffic splitting policy, and details are not described herein again.

In this embodiment of this application, because a plurality of link transmission modes are supported, a triggering condition or an enabling condition of each transmission mode may be determined by using a network configuration method or a system configuration method, so that the network implements a trade-off between power consumption and performance. In some embodiments, the determining the transmission mode of the link between the first device and the second device based on a first parameter may include any one of the following:

(I) The first device determines that the transmission mode of the link between the first device and the second device is the low power consumption mode in a case that the first device meets a first condition.

Herein, the first condition is a condition for triggering or enabling the low power consumption mode, and may include but is not limited to at least one of the following: a battery capacity of the first device and/or a battery capacity of the second device are/is less than a first threshold, the first device and/or the second device are/is overheated (for example, a temperature inside the first device and/or a temperature inside the second device exceed/exceeds a specific temperature threshold), a time in which the first device does not receive signaling for maintaining a performance mode exceeds a preset time length, a time in which the first device does not receive data or scheduling signaling in the performance mode exceeds the preset time length, or a size of a data packet that needs to be sent by the first device is less than a second threshold.

It should be noted that the first threshold, the preset time length, and the second threshold may be preset, network-configured, protocol-agreed, or the like, and may be limited based on an actual requirement. This is not limited.

(II) The first device determines that the transmission mode of the link between the first device and the second device is the performance mode in a case that the first device meets a second condition.

Herein, the second condition is a condition for triggering or enabling the performance mode, and may include but is not limited to at least one of the following: a size of a data packet that needs to be sent by the first device is greater than a third threshold, a quantity of times that a communication interruption occurs in the first device in a low power consumption mode exceeds a fourth threshold, a packet error rate of the first device in the low power consumption mode exceeds a fifth threshold, an out-of-synchronization state occurs in the first device in the low power consumption mode, or the first device is located in a preset weak communication coverage area.

It should be noted that the third threshold, the fourth threshold, and the fifth threshold may be preset, network-configured, protocol-agreed, or the like, and may be limited based on an actual requirement. This is not limited.

In some embodiments, after it is determined that the transmission mode of the link between the first device and the second device is the low power consumption mode, the determining the transmission mode of the link between the first device and the second device based on a first parameter may further include any one of the following:

(1) The first device determines that the transmission mode of the link between the first device and the second device is the first aggregated transmission mode in the low power consumption mode in a case that the first device meets a third condition.

Herein, the third condition is a condition for triggering or enabling the first aggregated transmission mode, and may include but is not limited to at least one of the following: a bandwidth required by a to-be-sent service of the first device is greater than a sixth threshold, a bandwidth required by a service (for example, a service requiring a large bandwidth, for example, extended reality XR, augmented reality AR, virtual reality VR, and a high-definition video) corresponding to the service type between the first device and the second device is greater than a seventh threshold, or a transmission rate (for example, a network throughput) between the first device and the second device is lower than an eighth threshold.

It should be noted that the sixth threshold, the seventh threshold, and the eighth threshold may be preset, network-configured, protocol-agreed, or the like, and may be limited based on an actual requirement. This is not limited.

(2) The first device determines that the transmission mode of the link between the first device and the second device is the first redundant transmission mode in the performance mode in a case that the first device meets a fourth condition.

Herein, the fourth condition is a condition for triggering or enabling the first redundant transmission mode, and may include but is not limited to at least one of the following: a signal quality parameter (for example, an RSRP, an RSSI, an RSRQ, an SINR, or an SNR) of the link between the first device and the second device is less than a ninth threshold, a packet loss rate, a frame error rate, or a bit error rate of a service between the first device and the second device is greater than a tenth threshold, or reliability of the service between the first device and the second device is lower than an eleventh threshold.

It should be noted that the ninth threshold, the tenth threshold, and the eleventh threshold may be preset, network-configured, protocol-agreed, or the like, and may be limited based on an actual requirement. This is not limited.

(3) The first device determines that the transmission mode of the link between the first device and the second device is the first optimal link transmission mode in the performance mode in a case that the first device meets a fifth condition.

Herein, the fifth condition is a condition for triggering or enabling the first optimal link transmission mode, and may include but is not limited to at least one of the following: a delay (for example, a maximum delay, a minimum delay, or an average delay) of a to-be-sent service of the first device is less than a twelfth threshold, a delay jitter (for example, a maximum delay jitter, a minimum delay jitter, or an average delay jitter) of the to-be-sent service of the first device is less than a thirteenth threshold, or a round trip time RTT of the to-be-sent service of the first device is less than a fourteenth threshold.

It should be noted that the twelfth threshold, the thirteenth threshold, and the fourteenth threshold may be preset, network-configured, protocol-agreed, or the like, and may be limited based on an actual requirement. This is not limited.

In some embodiments, after it is determined that the transmission mode of the link between the first device and the second device is the performance mode, the determining the transmission mode of the link between the first device and the second device based on a first parameter may further include any one of the following:

(4) The first device determines that the transmission mode of the link between the first device and the second device is the second aggregated transmission mode in the performance mode in a case that the first device meets a sixth condition.

Herein, the sixth condition is a condition for triggering or enabling the second aggregated transmission mode, and may include but is not limited to at least one of the following: a bandwidth required by a to-be-sent service of the first device is greater than a fifteenth threshold, a bandwidth required by a service (for example, a service requiring a large bandwidth, for example, extended reality XR, augmented reality AR, virtual reality VR, or a high-definition video) corresponding to the service type between the first device and the second device is greater than a sixteenth threshold, or a transmission rate between the first device and the second device is lower than a seventeenth threshold.

It should be noted that the fifteenth threshold, the sixteenth threshold, and the seventeenth threshold may be preset, network-configured, protocol-agreed, or the like, and may be limited based on an actual requirement. This is not limited.

(5) The first device determines that the transmission mode of the link between the first device and the second device is the second redundant transmission mode in the performance mode in a case that the first device meets a seventh condition.

Herein, the seventh condition is a condition for triggering or enabling the second redundant transmission mode, and may include but is not limited to at least one of the following: a signal quality parameter (for example, an RSRP, an RSSI, an RSRQ, an SINR, or an SNR) of the link between the first device and the second device is less than an eighteenth threshold, a packet loss rate, a frame error rate, or a bit error rate of a service between the first device and the second device is greater than a nineteenth threshold, or reliability of the service between the first device and the second device is lower than a twentieth threshold.

It should be noted that the eighteenth threshold, the nineteenth threshold, and the twentieth threshold may be preset, network-configured, protocol-agreed, or the like, and may be limited based on an actual requirement. This is not limited.

(6) The first device determines that the transmission mode of the link between the first device and the second device is the second optimal link transmission mode in the performance mode in a case that the first device meets an eighth condition.

Herein, the eighth condition is a condition for triggering or enabling the second optimal link transmission mode, and may include but is not limited to at least one of the following: a delay (for example, a maximum delay, a minimum delay, or an average delay) of a to-be-sent service of the first device is less than a twenty-first threshold, a delay jitter (for example, a maximum delay jitter, a minimum delay jitter, and an average delay jitter) of the to-be-sent service of the first device is less than a twenty-second threshold, or a round trip time RTT of the to-be-sent service of the first device is less than a twenty-third threshold.

It should be noted that the twenty-first threshold, the twenty-second threshold, and the twenty-third threshold may be preset, network-configured, protocol-agreed, or the like, and may be limited based on an actual requirement. This is not limited.

In the solution of this application, because the transmission mode of the link between the first device and the second device is determined based on the first parameter, obtaining the first parameter accurately and in time is a prerequisite for implementing this solution. Because the first parameter is a parameter set across a plurality of layers, manners of obtaining the first parameter may also be diverse. Descriptions are as follows:

### (1) Sensing of a Link State

In end-to-end multi-link transmission, the link transmission mode may be optimized by obtaining link state information, including obtaining link state information at a physical layer or a data link layer.

For the data link layer, retransmission information at the link layer may be used to sense the link state. Specifically, one manner is to directly modify a parameter of the data link layer, for example, record a data packet each time the data packet is retransmitted. Another manner is to directly read a related parameter of the data link layer, for example, a parameter in the MIB of the IEEE 802.11 series protocols.

For the physical layer, the link state may be sensed based on signal strength or quality, including parameters such as an RSRP, an RSRQ, an RSS, an RSSI, an SNR, or an SINR.

### (2) Estimation and Prediction of a Link Parameter

Links traversed by different subflows vary greatly in terms of a bandwidth and a delay and change dynamically. As a result, data packets on different subflows or links arrive at a receiver out of order. To ensure effective data allocation or select a link with a good link state, end-to-end link parameters of each link need to be used as a basis for optimization, including a bandwidth, a round trip time, a packet loss rate, or the like.

For example, an average delay at the link layer and a corresponding end-to-end round trip delay may be calculated based on a frame error rate of a link. For another example, Kalman filtering may be introduced into prediction of an end-to-end delay and a bandwidth, and a future bandwidth and a future round trip delay may be predicted by performing joint Kalman filtering prediction on a current bandwidth and a current round trip delay.

In bandwidth prediction, an available transmission bandwidth may be estimated based on a frame error rate of the link layer and the end-to-end round trip delay, and the available transmission bandwidth may be used as an evaluation criterion for link quality. Alternatively, in a cellular network, a feature of a physical layer of the cellular network may be used, to be specific, the base station adjusts a size of a transport block based on signal strength returned by the terminal, for example, channel quality indicator (CQI) information, calculates a downlink bandwidth of a user on a base station side by using transport block information, performs data allocation, or the like.

### (3) Obtaining of Another Service Parameter

For the service parameter, QoS characteristics of a service flow may be obtained by using a 5G QoS identifier (5QI) parameter similar to that defined in the 3GPP protocol, including a QoS class identifier (QCI), an allocation and retention priority (ARQ), a guaranteed bit rate (GBR), a maximum bit rate (MBR), or the like. Correspondingly, another network protocol also has similar definitions of service QoS.

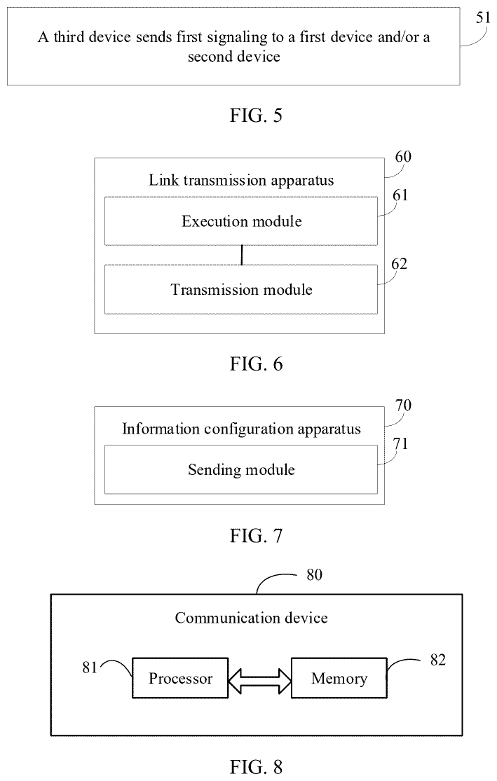

FIG. 5 is a flowchart of an information configuration method according to an embodiment of this application. The method is performed by a third device, and the third device is a third-party device different from a first device and a second device, for example, a network side device. As shown in FIG. 5, the method includes the following steps.

Step 51: The third device sends first signaling to the first device and/or the second device.

Herein, the first signaling is used to determine a transmission mode of a link between the first device and the second device, and perform transmission on the link determined based on the transmission mode; and the link between the first device and the second device includes at least one first link, and the first link is a low power communication link. For example, optional forms of the first device and the second device may include as follows: (1) Both the first device and the second device are terminals. (2) The first device is a terminal, and the second device is a network side device. (3) The first device is a network side device, and the second device is a terminal. (4) The first device is a BSC sending device, and the second device is a BSC receiving device.

In some embodiments, the first link may include at least one of the following:
(1) a backscatter communication link based on a third-party radio frequency carrier; or
(2) a low power communication link having an autonomous carrier generation capability.

In some embodiments, the first signaling may include at least one of the following:
an operating system instruction;
application layer signaling;
transport layer signaling;
network layer signaling; or
signaling in a protocol stack, where for example, the signaling in the protocol stack may be 3GPP signaling, Wi-Fi signaling, or the like; and the 3GPP signaling may optionally be at least one of the following: RRC signaling, a MAC CE, DCI, SCI, physical layer signaling, or the like.

In this way, link transmission of a related device can be implemented in a case that a low power communication technology is introduced. In addition, the transmission mode is properly selected/determined, so that balance between system performance and power consumption of multi-link transmission can be implemented, and system performance such as bandwidth aggregation, load balancing, dynamic switching, or the like between a plurality of links can be implemented on a premise that low power consumption of a system is ensured.

In some embodiments, the link between the first device and the second device may further include at least one second link, the second link is a communication link having a carrier generation capability, and average power consumption of the second link is higher than average power consumption of the first link, or peak power consumption of the second link is higher than peak power consumption of the first link.

For example, the link between the first device and the second device may have the following composition forms: (1) one first link and one second link; (2) one first link and a plurality of second links; (3) a plurality of first links and one second link; and (4) a plurality of first links and a plurality of second links.

In some embodiments, the second link is an active communication link having a carrier generation capability, and may include at least one of the following:
(1) a cellular link, where for example, the cellular link may be a cellular link in a communication system such as 4G, 5G, 6G, or B6G;
(2) a sidelink, where for example, the sidelink may be a sidelink in a communication system such as 4G, 5G, 6G, or B6G;
(3) a Wi-Fi link;
(4) a non-terrestrial network NTN link;
(5) an internet of things link, where for example, the internet of things link may be an internet of things link in a low power wide area network LPWAN such as NB-IoT or RedCap; or
(6) a short-range communication link, where for example, the short-range communication link may be a short-range communication link such as Zigbee, Bluetooth, or LoRa.

In some embodiments, the information configuration method in this embodiment may further include:

The third device determines the transmission mode of the link between the first device and the second device based on a first parameter, where the first parameter is a transmission-related parameter between the first device and the second device.

Herein, the transmission mode of the link between the first device and the second device is determined by the third device. The first parameter may optionally be a plurality of parameters across layers (for example, a physical layer, a link layer, a RAN higher layer, and an application layer), and may include at least one of the following:
a service type between the first device and the second device, where for example, the service type is a file service, a video service, a real-time streaming media service, or the like;
a size of a service packet between the first device and the second device;
a bandwidth requirement of a service between the first device and the second device;
a delay requirement of the service between the first device and the second device, where for example, the delay requirement may optionally be at least one of the following: a maximum delay, a minimum delay, and an average delay;
a delay jitter requirement between the first device and the second device, where for example, the delay jitter requirement may optionally be at least one of the following: a maximum delay jitter, a minimum delay jitter, and an average delay jitter;
a signal quality parameter of the link between the first device and the second device, where for example, the signal quality parameter of the link may optionally be at least one of the following: an RSRP, an RSSI, an RSRQ, an SINR, an SNR, or the like;
a system parameter of the link between the first device and the second device, where for example, the system parameter may optionally be at least one of the following: a frame error rate, a channel bandwidth, and an RTT; or
a power consumption parameter of the link between the first device and the second device, where for example, the power consumption parameter may optionally be at least one of the following: energy efficiency, average communication power consumption, peak communication power consumption, or the like.

In this way, a multi-link transmission mode may be selected/determined by combining a plurality of parameters across a physical layer, a link layer, a RAN higher layer, an application layer, or the like, to balance system performance and power consumption of multi-link transmission, and implement system performance such as bandwidth aggregation, load balancing, dynamic switching, or the like between a plurality of links on a premise that low power consumption of a system is ensured Performance.

In this embodiment of this application, the transmission mode may include any one of the following:
a low power consumption mode, where in this mode, only one or more first links are enabled; or
a performance mode, where in this mode, at least one first link and at least one second link are enabled.

In some embodiments, the low power consumption mode may include at least one of the following:

### (a) First Aggregated Transmission Mode

Herein, the first aggregated transmission mode may also be referred to as a parallel transmission mode or an aggregated mode. The first aggregated transmission mode may meet at least one of the following:
(I) at least two first links are enabled, and the at least two first links communicate different data packets;
(II) a plurality of first links are enabled, and data on the plurality of first links is traffic-split at a protocol layer; and in some embodiments, the protocol layer may include at least one of the following: an application layer, a transport layer, a network layer, an ATSSS-LL layer, a non-access stratum NAS, an RRC layer, an SDAP layer, a PDCP layer, an RLC layer, a MAC layer, or the like;
(III) a plurality of first links are enabled, and data packets sent by subflows corresponding to the plurality of first links each have at least one sequence number, used for data reassembly and/or sorting; or
(IV) a plurality of first links are enabled, and the plurality of first links are communicated in parallel.

### (b) First Redundant Transmission Mode

Herein, the first redundant transmission mode may also be referred to as a backup mode. The first redundant transmission mode may meet at least one of the following:
(I) at least two first links are enabled, and the at least two first links communicate a same data packet;
(II) a plurality of first links are enabled, and data on the plurality of first links is traffic-split at a protocol layer; and in some embodiments, the protocol layer may include at least one of the following: an application layer, a transport layer, a network layer, an ATSSS-LL layer, a non-access stratum NAS, an RRC layer, an SDAP layer, a PDCP layer, an RLC layer, a MAC layer, or the like;
(III) a plurality of first links are enabled, and data packets sent by subflows corresponding to the plurality of first links each have at least one sequence number, used for data reassembly and/or sorting; or
(IV) a plurality of first links are enabled, and the plurality of first links are communicated in parallel.

### (c) First Optimal Link Transmission Mode

Herein, the first optimal link transmission mode may also be referred to as a single-link transmission mode, that is, transmission is performed through only one sublink. The first optimal link transmission mode meets the following: only one first link is enabled at the same time.

In some embodiments, the first link enabled in the first optimal link transmission mode meets at least one of the following:
a round trip time RTT of the first link is minimum;
an available bandwidth of the first link is maximum;
link quality of the first link is best;
power consumption of the first link is lowest; or
a packet loss rate of the first link is lowest.

In some embodiments, the performance mode may include at least one of the following:

### (a) Second Aggregated Transmission Mode

Herein, the second aggregated transmission mode may also be referred to as a parallel transmission mode or an aggregated mode. The second aggregated transmission mode meets at least one of the following:
(I) the first link and the second link communicate different data packets, for example, at least one first link (that is, one or more first links) and at least one second link (that is, one or more second links) may communicate different data packets;
(II) data on the first link and data on the second link are traffic-split at a protocol layer, for example, data on at least one first link (that is, one or more first links) and data on at least one second link (that is, one or more second links) may be traffic-split at the protocol layer; and the protocol layer may include at least one of the following: an application layer, a transport layer, a network layer, an ATSSS-LL layer, a non-access stratum NAS, an RRC layer, an SDAP layer, a PDCP layer, an RLC layer, a MAC layer, or the like;
(III) data packets sent by subflows corresponding to the first link and the second link each have at least one sequence number, used for data reassembly and/or sorting, for example, data packets sent by subflows corresponding to at least one first link (that is, one or more first links) and at least one second link (that is, one or more second links) each may have at least one sequence number; or
(IV) the first link and the second link are communicated in parallel, for example, at least one first link (that is, one or more first links) and at least one second link (that is, one or more second links) may be communicated in parallel.

### (b) Second Redundant Transmission Mode

Herein, the second redundant transmission mode may also be referred to as a backup mode. The second redundant transmission mode may meet at least one of the following:
(I) the first link and the second link communicate a same data packet, for example, at least one first link (that is, one or more first links) and at least one second link (that is, one or more second links) may communicate a same data packet;
(II) data on the first link and data on the second link are traffic-split at a protocol layer, for example, data on at least one first link (that is, one or more first links) and data on at least one second link (that is, one or more second links) may be traffic-split at the protocol layer; and the protocol layer may include at least one of the following: an application layer, a transport layer, a network layer, an ATSSS-LL layer, a non-access stratum NAS, an RRC layer, an SDAP layer, a PDCP layer, an RLC layer, a MAC layer, or the like;
(III) data packets sent by subflows corresponding to the first link and the second link each have at least one sequence number, used for data reassembly and/or sorting, for example, data packets sent by subflows corresponding to at least one first link (that is, one or more first links) and at least one second link (that is, one or more second links) each may have at least one sequence number; or
(IV) the first link and the second link are communicated in parallel, for example, at least one first link (that is, one or more first links) and at least one second link (that is, one or more second links) may be communicated in parallel.

### (c) Second Optimal Link Transmission Mode

Herein, the second optimal link transmission mode may meet at least one of the following:
(I) at least one first link and one second link are enabled at the same time, that is, there is one and only one second link enabled;
(II) data on the first link and data on the second link are traffic-split at a protocol layer; and in some embodiments, the protocol layer may include at least one of the following: an application layer, a transport layer, a network layer, an ATSSS-LL layer, a non-access stratum NAS, an RRC layer, an SDAP layer, a PDCP layer, an RLC layer, a MAC layer, or the like;
(III) data packets sent by subflows corresponding to the first link and the second link each have at least one sequence number, used for at least one of the following: data reassembly, data sorting, or data combination, for example, data packets sent by subflows corresponding to at least one first link (that is, one or more first links) and one second link each may have at least one sequence number; or
(IV) the first link and the second link are communicated in parallel, for example, at least one first link (that is, one or more first links) and one second link may be communicated in parallel.

In some embodiments, the second link enabled in the second optimal link transmission mode meets at least one of the following:
a round trip time RTT of the second link is minimum;
a bandwidth of the second link is maximum;
link quality of the second link is best;
power consumption of the second link is lowest; or
a packet loss rate of the second link is lowest.

### (d) Serial Transmission Mode

Herein, the serial transmission mode meets at least one of the following: the first link and the second link are communicated in series. For example, at least one first link (that is, one or more first links) and at least one second link (that is, one or more second links) may be communicated in series.

In some embodiments, in the serial transmission mode, the first link is used to wake up or enable one or more second links; and/or the first link is used to communicate signaling or data, and the second link is used to communicate data.

In some embodiments, the determining the transmission mode of the link between the first device and the second device based on a first parameter may include any one of the following:

(I) The third device determines that the transmission mode of the link between the first device and the second device is the low power consumption mode in a case that the third device meets a first condition.

Herein, the first condition is a condition for triggering or enabling the low power consumption mode, and may include but is not limited to at least one of the following: a battery capacity of the first device and/or a battery capacity of the second device are/is less than a first threshold, the first device and/or the second device are/is overheated (for example, a temperature inside the first device and/or a temperature inside the second device exceed/exceeds a specific temperature threshold), a time in which the first device does not receive signaling for maintaining a performance mode exceeds a preset time length, a time in which the first device does not receive data or scheduling signaling in the performance mode exceeds the preset time length, or a size of a data packet that needs to be sent by the first device is less than a second threshold.

It should be noted that the first threshold, the preset time length, and the second threshold may be preset, network-configured, protocol-agreed, or the like, and may be limited based on an actual requirement. This is not limited.

(II) The third device determines that the transmission mode of the link between the first device and the second device is the performance mode in a case that the third device meets a second condition.

Herein, the second condition is a condition for triggering or enabling the performance mode, and may include but is not limited to at least one of the following: a size of a data packet that needs to be sent by the first device is greater than a third threshold, a quantity of times that a communication interruption occurs in the first device in a low power consumption mode exceeds a fourth threshold, a packet error rate of the first device in the low power consumption mode exceeds a fifth threshold, an out-of-synchronization state occurs in the first device in the low power consumption mode, or the first device is located in a preset weak communication coverage area.

It should be noted that the third threshold, the fourth threshold, and the fifth threshold may be preset, network-configured, protocol-agreed, or the like, and may be limited based on an actual requirement. This is not limited.

In some embodiments, after it is determined that the transmission mode of the link between the first device and the second device is the low power consumption mode, the determining the transmission mode of the link between the first device and the second device based on a first parameter may further include any one of the following:

(1) The third device determines that the transmission mode of the link between the first device and the second device is the first aggregated transmission mode in the low power consumption mode in a case that the third device meets a third condition.

Herein, the third condition is a condition for triggering or enabling the first aggregated transmission mode, and may include but is not limited to at least one of the following: a bandwidth required by a to-be-sent service of the first device is greater than a sixth threshold, a bandwidth required by a service (for example, a service requiring a large bandwidth, for example, extended reality XR, augmented reality AR, virtual reality VR, and a high-definition video) corresponding to the service type between the first device and the second device is greater than a seventh threshold, or a transmission rate (for example, a network throughput) between the first device and the second device is lower than an eighth threshold.

It should be noted that the sixth threshold, the seventh threshold, and the eighth threshold may be preset, network-configured, protocol-agreed, or the like, and may be limited based on an actual requirement. This is not limited.

(2) The third device determines that the transmission mode of the link between the first device and the second device is the first redundant transmission mode in the performance mode in a case that the third device meets a fourth condition.

Herein, the fourth condition is a condition for triggering or enabling the first redundant transmission mode, and may include but is not limited to at least one of the following: a signal quality parameter (for example, an RSRP, an RSSI, an RSRQ, an SINR, or an SNR) of the link between the first device and the second device is less than a ninth threshold, a packet loss rate, a frame error rate, or a bit error rate of a service between the first device and the second device is greater than a tenth threshold, or reliability of the service between the first device and the second device is lower than an eleventh threshold.

It should be noted that the ninth threshold, the tenth threshold, and the eleventh threshold may be preset, network-configured, protocol-agreed, or the like, and may be limited based on an actual requirement. This is not limited.

(3) The third device determines that the transmission mode of the link between the first device and the second device is the first optimal link transmission mode in the performance mode in a case that the third device meets a fifth condition.

Herein, the fifth condition is a condition for triggering or enabling the first optimal link transmission mode, and may include but is not limited to at least one of the following: a delay (for example, a maximum delay, a minimum delay, or an average delay) of a to-be-sent service of the first device is less than a twelfth threshold, a delay jitter (for example, a maximum delay jitter, a minimum delay jitter, and an average delay jitter) of the to-be-sent service of the first device is less than a thirteenth threshold, or a round trip time RTT of the to-be-sent service of the first device is less than a fourteenth threshold.

It should be noted that the twelfth threshold, the thirteenth threshold, and the fourteenth threshold may be preset, network-configured, protocol-agreed, or the like, and may be limited based on an actual requirement. This is not limited.

In some embodiments, after it is determined that the transmission mode of the link between the first device and the second device is the performance mode, the determining the transmission mode of the link between the first device and the second device based on a first parameter may further include any one of the following:

(4) The third device determines that the transmission mode of the link between the first device and the second device is the second aggregated transmission mode in the performance mode in a case that the third device meets a sixth condition.

Herein, the sixth condition is a condition for triggering or enabling the second aggregated transmission mode, and may include but is not limited to at least one of the following: a bandwidth required by a to-be-sent service of the first device is greater than a fifteenth threshold, a bandwidth required by a service (for example, a service requiring a large bandwidth, for example, extended reality XR, augmented reality AR, virtual reality VR, or a high-definition video) corresponding to the service type between the first device and the second device is greater than a sixteenth threshold, or a transmission rate between the first device and the second device is lower than a seventeenth threshold.

It should be noted that the fifteenth threshold, the sixteenth threshold, and the seventeenth threshold may be preset, network-configured, protocol-agreed, or the like, and may be limited based on an actual requirement. This is not limited.

(5) The third device determines that the transmission mode of the link between the first device and the second device is the second redundant transmission mode in the performance mode in a case that the third device meets a seventh condition.

Herein, the seventh condition is a condition for triggering or enabling the second redundant transmission mode, and may include but is not limited to at least one of the following: a signal quality parameter (for example, an RSRP, an RSSI, an RSRQ, an SINR, or an SNR) of the link between the first device and the second device is less than an eighteenth threshold, a packet loss rate, a frame error rate, or a bit error rate of a service between the first device and the second device is greater than a nineteenth threshold, or reliability of the service between the first device and the second device is lower than a twentieth threshold.

It should be noted that the eighteenth threshold, the nineteenth threshold, and the twentieth threshold may be preset, network-configured, protocol-agreed, or the like, and may be limited based on an actual requirement. This is not limited.

(6) The third device determines that the transmission mode of the link between the first device and the second device is the second optimal link transmission mode in the performance mode in a case that the third device meets an eighth condition.

Herein, the eighth condition is a condition for triggering or enabling the second optimal link transmission mode, and may include but is not limited to at least one of the following: a delay (for example, a maximum delay, a minimum delay, or an average delay) of a to-be-sent service of the first device is less than a twenty-first threshold, a delay jitter (for example, a maximum delay jitter, a minimum delay jitter, and an average delay jitter) of the to-be-sent service of the first device is less than a twenty-second threshold, or a round trip time RTT of the to-be-sent service of the first device is less than a twenty-third threshold.

It should be noted that the twenty-first threshold, the twenty-second threshold, and the twenty-third threshold may be preset, network-configured, protocol-agreed, or the like, and may be limited based on an actual requirement. This is not limited.

The link transmission method provided in the embodiments of this application may be performed by a link transmission apparatus. In the embodiments of this application, the link transmission apparatus provided in the embodiments of this application is described by using an example in which the link transmission apparatus performs the link transmission method.

FIG. 6 is a schematic diagram of a structure of a link transmission apparatus according to an embodiment of this application. The apparatus is used in a first device. As shown in FIG. 6, the link transmission apparatus 60 includes:
an execution module 61, configured to determine a transmission mode of a link between the first device and a second device, where the link between the first device and the second device includes at least one first link, and the first link is a low power communication link; and
a transmission module 62, configured to perform transmission on the link determined based on the transmission mode.

In some embodiments, the link between the first device and the second device further includes at least one second link, the second link is a communication link having a carrier generation capability, and average power consumption of the second link is higher than average power consumption of the first link, or peak power consumption of the second link is higher than peak power consumption of the first link.

In some embodiments, the first link includes at least one of the following:
a backscatter communication link based on a third-party radio frequency carrier; or
a low power communication link having an autonomous carrier generation capability.

In some embodiments, the second link includes at least one of the following:
a cellular link, a sidelink, a Wi-Fi link, a non-terrestrial network link, an internet of things link, or a short-range communication link.

In some embodiments, the execution module 61 is configured to perform at least one of the following:
determining the transmission mode of the link between the first device and the second device based on a first parameter, where the first parameter is a transmission-related parameter between the first device and the second device;
receiving first signaling sent by a third device, and determining the transmission mode of the link between the first device and the second device based on the first signaling; or
receiving first indication information sent by the second device, and determining the transmission mode of the link between the first device and the second device based on the first indication information.

In some embodiments, the first parameter includes at least one of the following:
a service type between the first device and the second device;
a size of a service packet between the first device and the second device;
a bandwidth requirement of a service between the first device and the second device;
a delay requirement of the service between the first device and the second device;
a delay jitter requirement between the first device and the second device;
a signal quality parameter of the link between the first device and the second device;
a system parameter of the link between the first device and the second device; or
a power consumption parameter of the link between the first device and the second device.

In some embodiments, the transmission mode includes any one of the following:
a low power consumption mode; or
a performance mode.

In some embodiments, the low power consumption mode includes at least one of the following:
a first aggregated transmission mode, where the first aggregated transmission mode meets at least one of the following: at least two first links are enabled, and the at least two first links communicate different data packets; a plurality of first links are enabled, and data on the plurality of first links is traffic-split at a protocol layer; a plurality of first links are enabled, and data packets sent by subflows corresponding to the plurality of first links each have at least one sequence number, used for data reassembly and/or sorting; or a plurality of first links are enabled, and the plurality of first links are communicated in parallel;
a first redundant transmission mode, where the first redundant transmission mode meets at least one of the following: at least two first links are enabled, and the at least two first links communicate a same data packet; a plurality of first links are enabled, and data on the plurality of first links is traffic-split at a protocol layer; a plurality of first links are enabled, and data packets sent by subflows corresponding to the plurality of first links each have at least one sequence number, used for data reassembly and/or sorting; or a plurality of first links are enabled, and the plurality of first links are communicated in parallel; or
a first optimal link transmission mode, where the first optimal link transmission mode meets the following: only one first link is enabled at the same time.

In some embodiments, the first link enabled in the first optimal link transmission mode meets at least one of the following:
a round trip time of the first link is minimum;
an available bandwidth of the first link is maximum;
link quality of the first link is best;
power consumption of the first link is lowest; or
a packet loss rate of the first link is lowest.

In some embodiments, the performance mode includes at least one of the following:
a second aggregated transmission mode, where the second aggregated transmission mode meets at least one of the following: the first link and the second link communicate different data packets; data on the first link and data on the second link are traffic-split at a protocol layer; data packets sent by subflows corresponding to the first link and the second link each have at least one sequence number, used for data reassembly and/or sorting; or the first link and the second link are communicated in parallel;
a second redundant transmission mode, where the second redundant transmission mode meets at least one of the following: the first link and the second link communicate a same data packet; data on the first link and data on the second link are traffic-split at a protocol layer; data packets sent by subflows corresponding to the first link and the second link each have at least one sequence number, used for data reassembly and/or sorting; or the first link and the second link are communicated in parallel;
a second optimal link transmission mode, where the second optimal link transmission mode meets at least one of the following: at least one first link and one second link are enabled at the same time; data on the first link and data on the second link are traffic-split at a protocol layer; data packets sent by subflows corresponding to the first link and the second link each have at least one sequence number, used for at least one of the following: data reassembly, data sorting, or data combination; or the first link and the second link are communicated in parallel; or
a serial transmission mode, where the serial transmission mode meets at least one of the following: the first link and the second link are communicated in series.

In some embodiments, the second link enabled in the second optimal link transmission mode meets at least one of the following:
a round trip time of the second link is minimum;
a bandwidth of the second link is maximum;
link quality of the second link is best;
power consumption of the second link is lowest; or
a packet loss rate of the second link is lowest; and/or
in the serial transmission mode, the first link is used to wake up or enable one or more second links; and/or the first link is used to communicate signaling or data, and the second link is used to communicate data.

In some embodiments, the protocol layer includes at least one of the following:
an application layer, a transport layer, a network layer, an ATSSS-LL layer, a NAS, an RRC layer, an SDAP layer, a PDCP layer, an RLC layer, or a MAC layer.

In some embodiments, the execution module 61 is configured to perform any one of the following:
determining that the transmission mode is a low power consumption mode in a case that a first condition is met, where the first condition includes at least one of the following: a battery capacity of the first device and/or a battery capacity of the second device are/is less than a first threshold, the first device and/or the second device are/is overheated, a time in which the first device does not receive signaling for maintaining a performance mode exceeds a preset time length, a time in which the first device does not receive data or scheduling signaling in the performance mode exceeds the preset time length, or a size of a data packet that needs to be sent by the first device is less than a second threshold; or
determining that the transmission mode is a performance mode in a case that a second condition is met, where the second condition includes at least one of the following: a size of a data packet that needs to be sent by the first device is greater than a third threshold, a quantity of times that a communication interruption occurs in the first device in a low power consumption mode exceeds a fourth threshold, a packet error rate of the first device in the low power consumption mode exceeds a fifth threshold, an out-of-synchronization state occurs in the first device in the low power consumption mode, or the first device is located in a preset weak communication coverage area.

In some embodiments, after determining that the transmission mode is the low power consumption mode, the execution module 61 may be further configured to perform any one of the following:
determining that the transmission mode is a first aggregated transmission mode in the low power consumption mode in a case that a third condition is met, where the third condition includes at least one of the following: a bandwidth required by a to-be-sent service of the first device is greater than a sixth threshold, a bandwidth required by a service corresponding to a service type between the first device and the second device is greater than a seventh threshold, or a transmission rate between the first device and the second device is lower than an eighth threshold;
determining that the transmission mode is a first redundant transmission mode in the performance mode in a case that a fourth condition is met, where the fourth condition includes at least one of the following: a signal quality parameter of the link between the first device and the second device is less than a ninth threshold, a packet loss rate, a frame error rate, or a bit error rate of a service between the first device and the second device is greater than a tenth threshold, or reliability of the service between the first device and the second device is lower than an eleventh threshold; or
determining that the transmission mode is a first optimal link transmission mode in the performance mode in a case that a fifth condition is met, where the fifth condition includes at least one of the following: a delay of a to-be-sent service of the first device is less than a twelfth threshold, a delay jitter of the to-be-sent service of the first device is less than a thirteenth threshold, or a round trip time of the to-be-sent service of the first device is less than a fourteenth threshold.

In some embodiments, after determining that the transmission mode is the performance mode, the execution module 61 may be further configured to perform any one of the following:
determining that the transmission mode is a second aggregated transmission mode in the performance mode in a case that a sixth condition is met, where the sixth condition includes at least one of the following: a bandwidth required by a to-be-sent service of the first device is greater than a fifteenth threshold, a bandwidth required by a service corresponding to a service type between the first device and the second device is greater than a sixteenth threshold, or a transmission rate between the first device and the second device is lower than a seventeenth threshold;
determining that the transmission mode is a second redundant transmission mode in the performance mode in a case that a seventh condition is met, where the seventh condition includes at least one of the following: a signal quality parameter of the link between the first device and the second device is less than an eighteenth threshold, a packet loss rate, a frame error rate, or a bit error rate of a service between the first device and the second device is greater than a nineteenth threshold, and reliability of the service between the first device or the second device is lower than a twentieth threshold; or
determining that the transmission mode is a second optimal link transmission mode in the performance mode in a case that an eighth condition is met, where the eighth condition includes at least one of the following: a delay of a to-be-sent service of the first device is less than a twenty-first threshold, a delay jitter of the to-be-sent service of the first device is less than a twenty-second threshold, or a round trip time of the to-be-sent service of the first device is less than a twenty-third threshold.

In some embodiments, the first signaling includes at least one of the following: an operating system instruction; application layer signaling; transport layer signaling; network layer signaling; or signaling in a protocol stack.

In some embodiments, the first indication information is sent by using at least one of the following: an operating system instruction; application layer signaling; transport layer signaling; network layer signaling; or signaling in a protocol stack.

The link transmission apparatus 60 provided in this embodiment of this application can implement the processes implemented in the embodiment of the link transmission method shown in FIG. 2, and same technical effect can be achieved. To avoid repetition, details are not described herein again.

FIG. 7 is a schematic diagram of a structure of an information configuration apparatus according to an embodiment of this application. The apparatus is used in a third device. As shown in FIG. 7, the information configuration apparatus 70 includes:
a sending module 71, configured to send first signaling to a first device and/or a second device.

Herein, the first signaling is used to determine a transmission mode of a link between the first device and the second device, and perform transmission on the link determined based on the transmission mode; and the link between the first device and the second device includes at least one first link, and the first link is a low power communication link.

In some embodiments, the link between the first device and the second device further includes at least one second link, the second link is a communication link having a carrier generation capability, and average power consumption of the second link is higher than average power consumption of the first link, or peak power consumption of the second link is higher than peak power consumption of the first link.

In some embodiments, the first link includes at least one of the following:
a backscatter communication link based on a third-party radio frequency carrier; or
a low power communication link having an autonomous carrier generation capability.

In some embodiments, the second link includes at least one of the following:
a cellular link, a sidelink, a Wi-Fi link, a non-terrestrial network link, an internet of things link, or a short-range communication link.

In some embodiments, the first signaling may include at least one of the following:
an operating system instruction;
application layer signaling;
transport layer signaling;
network layer signaling; or
signaling in a protocol stack, where for example, the signaling in the protocol stack may be 3GPP signaling, Wi-Fi signaling, or the like; and the 3GPP signaling may optionally be at least one of the following: RRC signaling, a MAC CE, DCI, SCI, physical layer signaling, or the like.

In some embodiments, the information configuration apparatus 70 further includes:
a determining module, configured to determine the transmission mode of the link between the first device and the second device based on a first parameter, where the first parameter is a transmission-related parameter between the first device and the second device.

In some embodiments, the first parameter includes at least one of the following:
a service type between the first device and the second device;
a size of a service packet between the first device and the second device;
a bandwidth requirement of a service between the first device and the second device;
a delay requirement of the service between the first device and the second device;
a delay jitter requirement between the first device and the second device;
a signal quality parameter of the link between the first device and the second device;
a system parameter of the link between the first device and the second device; or
a power consumption parameter of the link between the first device and the second device.

In some embodiments, the transmission mode includes any one of the following:
a low power consumption mode; or
a performance mode.

In some embodiments, the low power consumption mode includes at least one of the following:
a first aggregated transmission mode, where the first aggregated transmission mode meets at least one of the following: at least two first links are enabled, and the at least two first links communicate different data packets; a plurality of first links are enabled, and data on the plurality of first links is traffic-split at a protocol layer; a plurality of first links are enabled, and data packets sent by subflows corresponding to the plurality of first links each have at least one sequence number, used for data reassembly and/or sorting; or a plurality of first links are enabled, and the plurality of first links are communicated in parallel;
a first redundant transmission mode, where the first redundant transmission mode meets at least one of the following: at least two first links are enabled, and the at least two first links communicate a same data packet; a plurality of first links are enabled, and data on the plurality of first links is traffic-split at a protocol layer; a plurality of first links are enabled, and data packets sent by subflows corresponding to the plurality of first links each have at least one sequence number, used for data reassembly and/or sorting; or a plurality of first links are enabled, and the plurality of first links are communicated in parallel; or
a first optimal link transmission mode, where the first optimal link transmission mode meets the following: only one first link is enabled at the same time.

In some embodiments, the first link enabled in the first optimal link transmission mode meets at least one of the following:
a round trip time of the first link is minimum;
a bandwidth of the first link is maximum;
link quality of the first link is best;
power consumption of the first link is lowest; or
a packet loss rate of the first link is lowest.

In some embodiments, the performance mode includes at least one of the following:
a second aggregated transmission mode, where the second aggregated transmission mode meets at least one of the following: the first link and the second link communicate different data packets; data on the first link and data on the second link are traffic-split at a protocol layer; data packets sent by subflows corresponding to the first link and the second link each have at least one sequence number, used for data reassembly and/or sorting; or the first link and the second link are communicated in parallel;
a second redundant transmission mode, where the second redundant transmission mode meets at least one of the following: the first link and the second link communicate a same data packet; data on the first link and data on the second link are traffic-split at a protocol layer; data packets sent by subflows corresponding to the first link and the second link each have at least one sequence number, used for data reassembly and/or sorting; or the first link and the second link are communicated in parallel;
a second optimal link transmission mode, where the second optimal link transmission mode meets at least one of the following: at least one first link and one second link are enabled at the same time; data on the first link and data on the second link are traffic-split at a protocol layer; data packets sent by subflows corresponding to the first link and the second link each have at least one sequence number, used for at least one of the following: data reassembly, data sorting, or data combination; or the first link and the second link are communicated in parallel; or
a serial transmission mode, where the serial transmission mode meets at least one of the following: the first link and the second link are communicated in series.

In some embodiments, the second link enabled in the second optimal link transmission mode meets at least one of the following:
a round trip time of the second link is minimum;
a bandwidth of the second link is maximum;
link quality of the second link is best;
power consumption of the second link is lowest; or
a packet loss rate of the second link is lowest; and/or
in the serial transmission mode, the first link is used to wake up or enable one or more second links; and/or the first link is used to communicate signaling or data, and the second link is used to communicate data.

In some embodiments, the determining module is specifically configured to perform any one of the following:
determining that the transmission mode is a low power consumption mode in a case that a first condition is met, where the first condition includes at least one of the following: a battery capacity of the first device and/or a battery capacity of the second device are/is less than a first threshold, the first device and/or the second device are/is overheated, a time in which the first device does not receive signaling for maintaining a performance mode exceeds a preset time length, a time in which the first device does not receive data or scheduling signaling in the performance mode exceeds the preset time length, or a size of a data packet that needs to be sent by the first device is less than a second threshold; or
determining that the transmission mode is a performance mode in a case that a second condition is met, where the second condition includes at least one of the following: a size of a data packet that needs to be sent by the first device is greater than a third threshold, a quantity of times that a communication interruption occurs in the first device in a low power consumption mode exceeds a fourth threshold, a packet error rate of the first device in the low power consumption mode exceeds a fifth threshold, an out-of-synchronization state occurs in the first device in the low power consumption mode, or the first device is located in a preset weak communication coverage area.

In some embodiments, after determining that the transmission mode is the low power consumption mode, the determining module may be further configured to perform any one of the following:
determining that the transmission mode is a first aggregated transmission mode in the low power consumption mode in a case that a third condition is met, where the third condition includes at least one of the following: a bandwidth required by a to-be-sent service of the first device is greater than a sixth threshold, a bandwidth required by a service corresponding to a service type between the first device and the second device is greater than a seventh threshold, or a transmission rate between the first device and the second device is lower than an eighth threshold;
determining that the transmission mode is a first redundant transmission mode in the performance mode in a case that a fourth condition is met, where the fourth condition includes at least one of the following: a signal quality parameter of the link between the first device and the second device is less than a ninth threshold, a packet loss rate, a frame error rate, or a bit error rate of a service between the first device and the second device is greater than a tenth threshold, or reliability of the service between the first device and the second device is lower than an eleventh threshold; or
determining that the transmission mode is a first optimal link transmission mode in the performance mode in a case that a fifth condition is met, where the fifth condition includes at least one of the following: a delay of a to-be-sent service of the first device is less than a twelfth threshold, a delay jitter of the to-be-sent service of the first device is less than a thirteenth threshold, or a round trip time of the to-be-sent service of the first device is less than a fourteenth threshold.

In some embodiments, after determining that the transmission mode is the performance mode, the determining module may be further configured to perform any one of the following:
determining that the transmission mode is a second aggregated transmission mode in the performance mode in a case that a sixth condition is met, where the sixth condition includes at least one of the following: a bandwidth required by a to-be-sent service of the first device is greater than a fifteenth threshold, a bandwidth required by a service corresponding to a service type between the first device and the second device is greater than a sixteenth threshold, or a transmission rate between the first device and the second device is lower than a seventeenth threshold;
determining that the transmission mode is a second redundant transmission mode in the performance mode in a case that a seventh condition is met, where the seventh condition includes at least one of the following: a signal quality parameter of the link between the first device and the second device is less than an eighteenth threshold, a packet loss rate, a frame error rate, or a bit error rate of a service between the first device and the second device is greater than a nineteenth threshold, or reliability of the service between the first device and the second device is lower than a twentieth threshold; or
determining that the transmission mode is a second optimal link transmission mode in the performance mode in a case that an eighth condition is met, where the eighth condition includes at least one of the following: a delay of a to-be-sent service of the first device is less than a twenty-first threshold, a delay jitter of the to-be-sent service of the first device is less than a twenty-second threshold, or a round trip time of the to-be-sent service of the first device is less than a twenty-third threshold.

The information configuration apparatus 70 provided in this embodiment of this application can implement the processes implemented in the embodiment of the information configuration method shown in FIG. 5, and same technical effect can be achieved. To avoid repetition, details are not described herein again.

In some embodiments, as shown in FIG. 8, an embodiment of this application further provides a communication device 80, including a processor 81 and a memory 82. The memory 82 stores a program or an instruction that can be run on the processor 81. For example, when the communication device 80 is a first device, and the program or the instruction is executed by the processor 81, the steps of the embodiment of the link transmission method are implemented, and same technical effect can be achieved. When the communication device 80 is a second device, and the program or the instruction is executed by the processor 81, the steps of the embodiment of the information configuration method are implemented, and same technical effect can be achieved. To avoid repetition, details are not described herein again.

An embodiment of this application further provides a readable storage medium. The readable storage medium stores a program or an instruction; and when the program or the instruction is executed by a processor, the processes of the embodiment of the link transmission method are implemented, or the processes of the embodiment of the information configuration method are implemented, and same technical effect can be achieved. To avoid repetition, details are not described herein again.

The processor is a processor in the terminal in the foregoing embodiments. The readable storage medium includes a computer-readable storage medium, for example, a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface, the communication interface is coupled to the processor, and the processor is configured to run a program or an instruction, to implement the processes of the embodiment of the link transmission method, or implement the processes of the embodiment of the information configuration method, and same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the computer program/program product is executed by at least one processor, to implement the processes of the embodiment of the link transmission method or the processes of the embodiment of the information configuration method; and same technical effect can be achieved. To avoid repetition, details are not described herein again.

An embodiment of this application further provides a communication system. The communication system includes a first device and a second device, or includes a first device, a second device, and a third device. The first device/second device may be configured to perform the steps of the link transmission method, and the third device may be configured to perform the steps of the information configuration method.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements that are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and apparatus in the embodiments of this application is not limited to performing functions in the order shown or discussed, but may also include performing the functions in a basically simultaneous manner or in opposite order based on the functions involved. For example, the described method may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiments may be implemented by using a computer software product in addition to a necessary universal hardware platform, or certainly may be implemented by hardware. The computer software product is stored in a storage medium (such as a ROM, a RAM, a magnetic disk, or an optical disc), and includes several instructions for instructing a terminal or a network side device to perform the method described in the embodiments of this application.

The embodiments of this application are described above with reference to the accompanying drawings, but this application is not limited to the foregoing specific implementations, and the foregoing specific implementations are only illustrative and not restrictive.

1. A link transmission method, comprising:
determining, by a first device, a transmission mode of a link between the first device and a second device, wherein the link between the first device and the second device comprises at least one first link, and the first link is a low power communication link; and
performing, by the first device, transmission on the link determined based on the transmission mode.

2. The method according to claim 1, wherein the link between the first device and the second device further comprises at least one second link, the second link is a communication link having a carrier generation capability, and average power consumption of the second link is higher than average power consumption of the first link, or peak power consumption of the second link is higher than peak power consumption of the first link.

3. The method according to claim 1, wherein the determining, by a first device, a transmission mode of a link between the first device and a second device comprises at least one of the following:
determining, by the first device, the transmission mode of the link between the first device and the second device based on a first parameter, wherein the first parameter is a transmission-related parameter between the first device and the second device;
receiving, by the first device, first signaling sent by a third device, and determining the transmission mode of the link between the first device and the second device based on the first signaling; or
receiving, by the first device, first indication information sent by the second device, and determining the transmission mode of the link between the first device and the second device based on the first indication information;
wherein the first parameter comprises at least one of the following:
a service type between the first device and the second device;
a size of a service packet between the first device and the second device;
a bandwidth requirement of a service between the first device and the second device;
a delay requirement of the service between the first device and the second device;
a delay jitter requirement between the first device and the second device;
a signal quality parameter of the link between the first device and the second device;
a system parameter of the link between the first device and the second device; or
a power consumption parameter of the link between the first device and the second device.

4. The method according to claim 1, wherein the transmission mode comprises any one of the following:
a low power consumption mode; or
a performance mode.

5. The method according to claim 4, wherein the low power consumption mode comprises at least one of the following:
a first aggregated transmission mode, wherein the first aggregated transmission mode meets at least one of the following: at least two first links are enabled, and the at least two first links communicate different data packets; a plurality of first links are enabled, and data on the plurality of first links is traffic-split at a protocol layer; a plurality of first links are enabled, and data packets sent by subflows corresponding to the plurality of first links each have at least one sequence number, used for data reassembly and/or sorting; or a plurality of first links are enabled, and the plurality of first links are communicated in parallel;
a first redundant transmission mode, wherein the first redundant transmission mode meets at least one of the following: at least two first links are enabled, and the at least two first links communicate a same data packet; a plurality of first links are enabled, and data on the plurality of first links is traffic-split at a protocol layer; a plurality of first links are enabled, and data packets sent by subflows corresponding to the plurality of first links each have at least one sequence number, used for data reassembly and/or sorting; or a plurality of first links are enabled, and the plurality of first links are communicated in parallel; or
a first optimal link transmission mode, wherein the first optimal link transmission mode meets the following: only one first link is enabled at the same time;
wherein the first link enabled in the first optimal link transmission mode meets at least one of the following:
a round trip time of the first link is minimum;
an available bandwidth of the first link is maximum;
link quality of the first link is best;
power consumption of the first link is lowest; or
a packet loss rate of the first link is lowest.

6. The method according to claim 4, wherein the performance mode comprises at least one of the following:
a second aggregated transmission mode, wherein the second aggregated transmission mode meets at least one of the following: the first link and the second link communicate different data packets; data on the first link and data on the second link are traffic-split at a protocol layer; data packets sent by subflows corresponding to the first link and the second link each have at least one sequence number, used for data reassembly and/or sorting; or the first link and the second link are communicated in parallel;
a second redundant transmission mode, wherein the second redundant transmission mode meets at least one of the following: the first link and the second link communicate a same data packet; data on the first link and data on the second link are traffic-split at a protocol layer; data packets sent by subflows corresponding to the first link and the second link each have at least one sequence number, used for data reassembly and/or sorting; or the first link and the second link are communicated in parallel;
a second optimal link transmission mode, wherein the second optimal link transmission mode meets at least one of the following: at least one first link and one second link are enabled at the same time; data on the first link and data on the second link are traffic-split at a protocol layer; data packets sent by subflows corresponding to the first link and the second link each have at least one sequence number, used for at least one of the following: data reassembly, data sorting, or data combination; or the first link and the second link are communicated in parallel; or
a serial transmission mode, wherein the serial transmission mode meets at least one of the following: the first link and the second link are communicated in series, wherein
the second link is a communication link having a carrier generation capability;
wherein the second link enabled in the second optimal link transmission mode meets at least one of the following:
a round trip time of the second link is minimum;
a bandwidth of the second link is maximum;
link quality of the second link is best;
power consumption of the second link is lowest; or
a packet loss rate of the second link is lowest;
and/or
in the serial transmission mode, the first link is used to wake up or enable one or more second links; and/or the first link is used to communicate signaling or data, and the second link is used to communicate data.

7. The method according to claim 5, wherein the protocol layer comprises at least one of the following:
an application layer, a transport layer, a network layer, an access traffic steering, switching, and splitting-lower layer (ATSSS-LL) layer, a non-access stratum (NAS), a radio resource control (RRC) layer, a service data adaptation protocol (SDAP) layer, a packet data convergence protocol (PDCP) layer, a radio link control (RLC) layer, or a media access control (MAC) layer.

8. The method according to claim 3, wherein the determining, by the first device, the transmission mode of the link between the first device and the second device based on a first parameter comprises any one of the following:
determining, by the first device, that the transmission mode is a low power consumption mode in a case that the first device meets a first condition, wherein the first condition comprises at least one of the following: a battery capacity of the first device and/or a battery capacity of the second device are/is less than a first threshold, the first device and/or the second device are/is overheated, a time in which the first device does not receive signaling for maintaining a performance mode exceeds a preset time length, a time in which the first device does not receive data or scheduling signaling in the performance mode exceeds the preset time length, or a size of a data packet that needs to be sent by the first device is less than a second threshold; or
determining, by the first device, that the transmission mode is a performance mode in a case that the first device meets a second condition, wherein the second condition comprises at least one of the following: a size of a data packet that needs to be sent by the first device is greater than a third threshold, a quantity of times that a communication interruption occurs in the first device in a low power consumption mode exceeds a fourth threshold, a packet error rate of the first device in the low power consumption mode exceeds a fifth threshold, an out-of-synchronization state occurs in the first device in the low power consumption mode, or the first device is located in a preset weak communication coverage area.

9. The method according to claim 8, wherein after determining that the transmission mode is the low power consumption mode, the determining the transmission mode of the link between the first device and the second device based on a first parameter further comprises any one of the following:
determining, by the first device, that the transmission mode is a first aggregated transmission mode in the low power consumption mode in a case that the first device meets a third condition, wherein the third condition comprises at least one of the following: a bandwidth required by a to-be-sent service of the first device is greater than a sixth threshold, a bandwidth required by a service corresponding to a service type between the first device and the second device is greater than a seventh threshold, or a transmission rate between the first device and the second device is lower than an eighth threshold;
determining, by the first device, that the transmission mode is a first redundant transmission mode in the performance mode in a case that the first device meets a fourth condition, wherein the fourth condition comprises at least one of the following: a signal quality parameter of the link between the first device and the second device is less than a ninth threshold, a packet loss rate, a frame error rate, or a bit error rate of a service between the first device and the second device is greater than a tenth threshold, or reliability of the service between the first device and the second device is lower than an eleventh threshold; or
determining, by the first device, that the transmission mode is a first optimal link transmission mode in the performance mode in a case that the first device meets a fifth condition, wherein the fifth condition comprises at least one of the following: a delay of a to-be-sent service of the first device is less than a twelfth threshold, a delay jitter of the to-be-sent service of the first device is less than a thirteenth threshold, or a round trip time of the to-be-sent service of the first device is less than a fourteenth threshold;
or,
wherein after determining that the transmission mode is the performance mode, the determining the transmission mode of the link between the first device and the second device based on a first parameter further comprises any one of the following:
determining, by the first device, that the transmission mode is a second aggregated transmission mode in the performance mode in a case that the first device meets a sixth condition, wherein the sixth condition comprises at least one of the following: a bandwidth required by a to-be-sent service of the first device is greater than a fifteenth threshold, a bandwidth required by a service corresponding to a service type between the first device and the second device is greater than a sixteenth threshold, or a transmission rate between the first device and the second device is lower than a seventeenth threshold;
determining, by the first device, that the transmission mode is a second redundant transmission mode in the performance mode in a case that the first device meets a seventh condition, wherein the seventh condition comprises at least one of the following: a signal quality parameter of the link between the first device and the second device is less than an eighteenth threshold, a packet loss rate, a frame error rate, or a bit error rate of a service between the first device and the second device is greater than a nineteenth threshold, or reliability of the service between the first device and the second device is lower than a twentieth threshold; or
determining, by the first device, that the transmission mode is a second optimal link transmission mode in the performance mode in a case that the first device meets an eighth condition, wherein the eighth condition comprises at least one of the following: a delay of a to-be-sent service of the first device is less than a twenty-first threshold, a delay jitter of the to-be-sent service of the first device is less than a twenty-second threshold, or a round trip time of the to-be-sent service of the first device is less than a twenty-third threshold.

10. An information configuration method, comprising:
sending, by a third device, first signaling to a first device and/or a second device, wherein
the first signaling is used to determine a transmission mode of a link between the first device and the second device, and perform transmission on the link determined based on the transmission mode; and the link between the first device and the second device comprises at least one first link, and the first link is a low power communication link.

11. The method according to claim 10, wherein the link between the first device and the second device further comprises at least one second link, the second link is a communication link having a carrier generation capability, and average power consumption of the second link is higher than average power consumption of the first link, or peak power consumption of the second link is higher than peak power consumption of the first link.

12. The method according to claim 10, wherein the method further comprises:
determining, by the third device, the transmission mode of the link between the first device and the second device based on a first parameter, wherein the first parameter is a transmission-related parameter between the first device and the second device;
wherein the first parameter comprises at least one of the following:
a service type between the first device and the second device;
a size of a service packet between the first device and the second device;
a bandwidth requirement of a service between the first device and the second device;
a delay requirement of the service between the first device and the second device;
a delay jitter requirement between the first device and the second device;
a signal quality parameter of the link between the first device and the second device;
a system parameter of the link between the first device and the second device; or
a power consumption parameter of the link between the first device and the second device.

13. The method according to claim 10, wherein the transmission mode comprises any one of the following:
a low power consumption mode; or
a performance mode.

14. The method according to claim 13, wherein the low power consumption mode comprises at least one of the following:
a first aggregated transmission mode, wherein the first aggregated transmission mode meets at least one of the following: at least two first links are enabled, and the at least two first links communicate different data packets; a plurality of first links are enabled, and data on the plurality of first links is traffic-split at a protocol layer; a plurality of first links are enabled, and data packets sent by subflows corresponding to the plurality of first links each have at least one sequence number, used for data reassembly and/or sorting; or a plurality of first links are enabled, and the plurality of first links are communicated in parallel;
a first redundant transmission mode, wherein the first redundant transmission mode meets at least one of the following: at least two first links are enabled, and the at least two first links communicate a same data packet; a plurality of first links are enabled, and data on the plurality of first links is traffic-split at a protocol layer; a plurality of first links are enabled, and data packets sent by subflows corresponding to the plurality of first links each have at least one sequence number, used for data reassembly and/or sorting; or a plurality of first links are enabled, and the plurality of first links are communicated in parallel; or
a first optimal link transmission mode, wherein the first optimal link transmission mode meets the following: only one first link is enabled at the same time;
wherein the first link enabled in the first optimal link transmission mode meets at least one of the following:
a round trip time of the first link is minimum;
a bandwidth of the first link is maximum;
link quality of the first link is best;
power consumption of the first link is lowest; or
a packet loss rate of the first link is lowest.

15. The method according to claim 13, wherein the performance mode comprises at least one of the following:
a second aggregated transmission mode, wherein the second aggregated transmission mode meets at least one of the following: the first link and the second link communicate different data packets; data on the first link and data on the second link are traffic-split at a protocol layer; data packets sent by subflows corresponding to the first link and the second link each have at least one sequence number, used for data reassembly and/or sorting; or the first link and the second link are communicated in parallel;
a second redundant transmission mode, wherein the second redundant transmission mode meets at least one of the following: the first link and the second link communicate a same data packet; data on the first link and data on the second link are traffic-split at a protocol layer; data packets sent by subflows corresponding to the first link and the second link each have at least one sequence number, used for data reassembly and/or sorting; or the first link and the second link are communicated in parallel;
a second optimal link transmission mode, wherein the second optimal link transmission mode meets at least one of the following: at least one first link and one second link are enabled at the same time; data on the first link and data on the second link are traffic-split at a protocol layer; data packets sent by subflows corresponding to the first link and the second link each have at least one sequence number, used for at least one of the following: data reassembly, data sorting, or data combination; or the first link and the second link are communicated in parallel; or
a serial transmission mode, wherein the serial transmission mode meets at least one of the following: the first link and the second link are communicated in series, wherein
the second link is a communication link having a carrier generation capability;
wherein the second link enabled in the second optimal link transmission mode meets at least one of the following:
a round trip time of the second link is minimum;
a bandwidth of the second link is maximum;
link quality of the second link is best;
power consumption of the second link is lowest; or
a packet loss rate of the second link is lowest;
and/or
in the serial transmission mode, the first link is used to wake up or enable one or more second links; and/or the first link is used to communicate signaling or data, and the second link is used to communicated data.

16. The method according to claim 14, wherein the protocol layer comprises at least one of the following:
an application layer, a transport layer, a network layer, an access traffic steering, switching, and splitting-lower layer (ATSSS-LL) layer, a non-access stratum (NAS), a radio resource control (RRC) layer, a service data adaptation protocol (SDAP), a packet data convergence protocol (PDCP), a radio link control (RLC) layer, or a media access control (MAC) layer.

17. The method according to claim 12, wherein the determining, by the third device, the transmission mode of the link between the first device and the second device based on a first parameter comprises any one of the following:
determining, by the third device, that the transmission mode is a low power consumption mode in a case that the third device meets a first condition, wherein the first condition comprises at least one of the following: a battery capacity of the first device and/or a battery capacity of the second device are/is less than a first threshold, the first device and/or the second device are/is overheated, a time in which the first device does not receive signaling for maintaining a performance mode exceeds a preset time length, a time in which the first device does not receive data or scheduling signaling in the performance mode exceeds the preset time length, or a size of a data packet that needs to be sent by the first device is less than a second threshold; or
determining, by the third device, that the transmission mode is a performance mode in a case that the third device meets a second condition, wherein the second condition comprises at least one of the following: a size of a data packet that needs to be sent by the first device is greater than a third threshold, a quantity of times that a communication interruption occurs in the first device in a low power consumption mode exceeds a fourth threshold, a packet error rate of the first device in the low power consumption mode exceeds a fifth threshold, an out-of-synchronization state occurs in the first device in the low power consumption mode, or the first device is located in a preset weak communication coverage area.

18. The method according to claim 17, wherein after determining that the transmission mode is the low power consumption mode, the determining the transmission mode of the link between the first device and the second device based on a first parameter further comprises any one of the following:
determining, by the third device, that the transmission mode is a first aggregated transmission mode in the low power consumption mode in a case that the third device meets a third condition, wherein the third condition comprises at least one of the following: a bandwidth required by a to-be-sent service of the first device is greater than a sixth threshold, a bandwidth required by a service corresponding to a service type between the first device and the second device is greater than a seventh threshold, or a transmission rate between the first device and the second device is lower than an eighth threshold;
determining, by the third device, that the transmission mode is a first redundant transmission mode in the performance mode in a case that the third device meets a fourth condition, wherein the fourth condition comprises at least one of the following: a signal quality parameter of the link between the first device and the second device is less than a ninth threshold, a packet loss rate, a frame error rate, or a bit error rate of a service between the first device and the second device is greater than a tenth threshold, or reliability of the service between the first device and the second device is lower than an eleventh threshold; or
determining, by the third device, that the transmission mode is a first optimal link transmission mode in the performance mode in a case that the third device meets a fifth condition, wherein the fifth condition comprises at least one of the following: a delay of a to-be-sent service of the first device is less than a twelfth threshold, a delay jitter of the to-be-sent service of the first device is less than a thirteenth threshold, or a round trip time of the to-be-sent service of the first device is less than a fourteenth threshold;
or,
wherein after determining that the transmission mode is the performance mode, the determining the transmission mode of the link between the first device and the second device based on a first parameter further comprises any one of the following:
determining, by the third device, that the transmission mode is a second aggregated transmission mode in the performance mode in a case that the third device meets a sixth condition, wherein the sixth condition comprises at least one of the following: a bandwidth required by a to-be-sent service of the first device is greater than a fifteenth threshold, a bandwidth required by a service corresponding to a service type between the first device and the second device is greater than a sixteenth threshold, or a transmission rate between the first device and the second device is lower than a seventeenth threshold;
determining, by the third device, that the transmission mode is a second redundant transmission mode in the performance mode in a case that the third device meets a seventh condition, wherein the seventh condition comprises at least one of the following: a signal quality parameter of the link between the first device and the second device is less than an eighteenth threshold, a packet loss rate, a frame error rate, or a bit error rate of a service between the first device and the second device is greater than a nineteenth threshold, or reliability of the service between the first device and the second device is lower than a twentieth threshold; or
determining, by the third device, that the transmission mode is a second optimal link transmission mode in the performance mode in a case that the third device meets an eighth condition, wherein the eighth condition comprises at least one of the following: a delay of a to-be-sent service of the first device is less than a twenty-first threshold, a delay jitter of the to-be-sent service of the first device is less than a twenty-second threshold, or a round trip time of the to-be-sent service of the first device is less than a twenty-third threshold.

19. A communication device, the communication device is a first device, comprising a processor and a memory, wherein the memory stores a program or an instruction that can be run on the processor; wherein the program or the instruction, when executed by the processor, causes the first device to perform:
determining a transmission mode of a link between the first device and a second device, wherein the link between the first device and the second device comprises at least one first link, and the first link is a low power communication link; and
performing transmission on the link determined based on the transmission mode.

20. A communication device, comprising a processor and a memory, wherein the memory stores a program or an instruction that can be run on the processor, and when the program or the instruction is executed by the processor, the steps of the information configuration method according to claim 10 are implemented.
